(19) United States
(12) Patent Application Publication
(10) Pub. No.: US 2024/0202823 A1
(43) Pub. Date: Jun. 20, 2024

(54) ALTERNATIVE TRADING SYSTEM WITH FIRM ORDERS

(71) Applicant: Zanbato, Inc., Mountain View, CA (US)

(72) Inventors: Knut Nicolai SAND, Palo Alto, CA (US); David Harvey Dunford, San Francisco, CA (US); Gregory L. Wright, Teton Village, WY (US); Evangelia Zorotheos, East Hampton, NY (US)

(21) Appl. No.: 18/359,625

(22) Filed: Jul. 26, 2023

Related U.S. Application Data
(63) Continuation of application No. 17/669,776, filed on Feb. 11, 2022, now abandoned.
Application No. 17/669,776 is a continuation of application No. 17/020,506, filed on Sep. 14, 2020, now abandoned.
Application No. 17/020,506 is a continuation of application No. 16/231,722, filed on Dec. 24, 2018, now abandoned.
(60) Provisional application No. 62/609,836, filed on Dec. 22, 2017.

(51) Int. Cl. G06Q 40/04; G06F 3/0482; G06Q 20/14; G06Q 40/06

(52) U.S. Cl. CPC G06Q 40/04; G06Q 20/14; G06Q 40/06; G06F 3/0482

(57) ABSTRACT

A system and method for converting indications of interest to trade a private security into a firm order or intent to trade the security in a trading marketplace. The indications of interest can be converted into the firm order upon receipt of authorization information. The indication od interest is non-binding upon the parties until the trade is completed, and whereupon an economic fee is due. If the firm order is created and placed in the trading marketplace, then once a counterparty to the trade has been identified, the parties are obligated to close the trade. If the trade is not completed, then one of the parties pays the economic fee that is typically associated with the trade.

### RELATED APPLICATION

This application is a continuation of U.S. patent application Ser. No. 17/669,776, filed on Feb. 11, 2022, which is a continuation of U.S. patent application Ser. No. 17/020,506, filed on Sep. 14, 2020, which is a continuation of U.S. patent application Ser. No. 16/231,722, filed on Dec. 24, 2018, which claims priority to provisional patent application Ser. No. 62/609,836, filed on Dec. 22, 2017, both entitled ALTERNATIVE TRADING SYSTEM WITH FIRM ORDERS, the contents of which are all herein incorporated by reference.

### BACKGROUND OF THE INVENTION

The present invention relates to trading software and systems, and more specifically relates to alternative trading systems for executing orders involving tradeable assets.

Conventional trading systems employ trading software that facilitates the trading and analysis of financial products, such as stocks or currencies. Oftentimes, brokerage houses or firms provide clients with trading software to easily place trades and manage their accounts, but traders can also purchase third party trading software that supplements or enhances the software from the brokerage firm. Trading software has proliferated in recent years due to the growing popularity of electronic communication networks (ECNs) and the availability of application programming interfaces (APIs). ECNs are alternative trading networks or systems that enable trading outside of traditional stock exchanges or bourses, which have made it far more cost-effective for discount brokers to offer their own trading software. At the same time, APIs that provide real-time price and fundamental data have made it easier for third-party software developers to enter the market.

There are many different types of trading software with different features provided by both brokerages and third-party developers. These types of trading software have a number of features, including the ability to place trades and perform technical and fundamental asset analysis. The conventional trading systems have a number of benefits, including the ability to place trades outside of the market, remove cognitive bias during trading, and save the system user time.

There are drawbacks, however, to these conventional trading systems. The various trading software packages currently on the market are not compatible with each other, the fee structure associated with trading on the various platform are quite steep, and the trading platforms can be difficult to use and optimize. Further, traders on the platform can renege on proposed trades, thus costing the system providers time and money.

### SUMMARY OF THE INVENTION

It is thus an object of the present invention to provide an alternative trading system that allows the traders to trade instruments and execute firm orders, while ensuring that the broker managing and maintaining the trading system receives a brokerage fee associated with the firm order. Although the trading system of the present invention can be employed to trade any selected type of interest, according to one practice the trading system can be configured to trade private securities, that is, securities that are not registered and that are not listed on a registered national securities exchange. The transactions executed through the trading system typically do not involve securities that are centrally cleared, but that rather are cleared and settled by the parties to the transaction by means of suitable closing documents agreed to by the parties.

According to the present invention, the orders on the trading system may be entered as an indications of interest, which can include a request for a firm order. The indications of interest can be converted to a firm order after selected types of information, such as authorization information, is provided to the trading system by the subscriber or authorized user posting the trade. The subscriber or authorized user may cancel the trade posted in the trading system at any time prior to executing a stock transfer agreement or prior to a counterparty being identified without penalty. However, once a counterparty to the trade has been identified, the subscriber or authorized user is obligated to close the trade on the terms specified. If the trade is not consummated between the parties, then one of the parties pays an economic fee (e.g., broker fee) that is typically associated with the trade. The obligation of one or more of the parties to pay the economic fee forms part of the firm order concept of the present invention. Further, the parties to the transaction, e.g., the buyer and the seller, once the closing documentation is executed, are obligated to complete the transaction.

The present invention is directed to a method, implemented by a computing device, for receiving an indication of an interest submitted by a first subscriber or authorized user for display on a user interface, where the indication of interest includes an interest in a private security; receiving a request to convert the indication of interest into a firm order from the first subscriber or authorized user, where the firm order having an economic fee associated therewith; and generating a request for authorization information from the first subscriber or authorized user indicating that the first subscriber or authorized user is authorized to convert the indication of interest into a firm order. If the first subscriber or authorized user is authorized to submit the firm order, then receiving authorization information from the first subscriber or authorized user. Once the authorization information is received, converting the indication of interest into the firm order. The indication of interest can be placed into the digital trading marketplace or the firm order can be placed into a digital trading marketplace. The method includes receiving a request from the second subscriber or authorized user to proceed with a transaction involving the firm order, and matching the second subscriber or authorized user to the firm order submitted by the first subscriber or authorized user to form a trade. Once matched, the economic fee is due and payable by one of the first subscriber or authorized user or the second subscriber or authorized user independent of completion of the trade.

The method further includes receiving information associated with the indication of interest from the first subscriber or authorized user and stored in a storage element for review by a second subscriber or authorized user on the user interface. The indication of interest can include trade information including a company name, a number of shares to be traded, a price per share, a magnitude of the economic fee, and an indicator that the indication of interest is a bid or an offer. The method can further include receiving a request to submit the indication of interest with the trade information associated therewith.

The method can also include generating information associated with the company for display on the user interface including a number of indications of interest associated with the company, a number of firm orders associated with the company, and bid offer information associated with the company. The bid and offer information includes share price information offered on one or more shares of the company or share price information bid on one or more shares of the company.

The present invention an also include a non-transitory storage medium storing instructions that cause a processor to receive an indication of an interest submitted by a first subscriber or authorized user for display on a user interface, wherein the indication of interest includes an interest in a private security; receive a request to convert the indication of interest into a firm order from the first subscriber or authorized user, the firm order having an economic fee associated therewith; and generate a request for authorization information from the first subscriber or authorized user indicating that the first subscriber or authorized user is authorized to convert the indication of interest into a firm order. If the first subscriber or authorized user is authorized to submit the firm order, then receive authorization information from the first subscriber or authorized user, where the authorization information is stored in the storage element. The indication of interest is then converted into the firm order. The indication of interest can be placed into the trading marketplace or the firm order can be placed into the trading marketplace. The invention is also configured such that it includes receiving a request from the second subscriber or authorized user to proceed with a transaction involving the firm order, and matching the second subscriber or authorized user to the firm order submitted by the first subscriber or authorized user to form a trade. Once matched, the economic fee is due and payable by one of the first subscriber or authorized user or the second subscriber or authorized user independent of completion of the trade.

The non-transitory storage medium can also receive information associated with the indication of interest from the first subscriber or authorized user and stored in a storage element for review by a second subscriber or authorized user on the user interface.

The present invention is also directed to a computing device, comprising a storage clement, a display if needed or required, and a processor for executing instructions to receive an indication of an interest submitted by a first subscriber or authorized user for display on a user interface, where the indication of interest includes an interest in a private security; receive a request to convert the indication of interest into a firm order from the first subscriber or authorized user, where the firm order includes an economic fee associated therewith; and generate a request for authorization information from the first subscriber or authorized user indicating that the first subscriber or authorized user is authorized to convert the indication of interest into a firm order. If the first subscriber or authorized user is authorized to submit the firm order, receive authorization information from the first subscriber or authorized user, where the authorization information is stored in the storage element. The device or system is also configured to convert the indication of interest into the firm order. The indication of interest and/or the firm order can be placed into a digital trading marketplace. The device or system can also be configured to receive a request from the second subscriber or authorized user to proceed with a transaction involving the firm order, and match the second subscriber or authorized user to the firm order submitted by the first subscriber or authorized user to form a trade. Once matched, the economic fee is due and payable by one of the first subscriber or authorized user or the second subscriber or authorized user independent of completion of the trade.

The processor can be further programmed to receive information associated with the indication of interest from the first subscriber or authorized user and stored in a storage element for review by a second subscriber or authorized user on the user interface.

The present invention is also directed to a method, implemented by a computing device, comprising transmitting a first user interface to obtain information from a first subscriber or authorized user for an indication of interest in a company, where the indication of interest includes an interest in a private security; receiving from the first subscriber or authorized user the information about the indication of interest in the company, where the information about the indication of interest in the company is stored in a storage element; receiving information associated with the indication of interest from the first subscriber or authorized user and stored in a storage element for review by a second subscriber or authorized user on the user interface;

transmitting to the first subscriber or authorized user a second user interface to obtain instructions to convert the indication of interest into a firm order, the firm order having an economic fee associated therewith; receiving from the first subscriber or authorized user a request to convert the indication of interest into a firm order; transmitting a third user interface to obtain an authorization agreement authorizing the first subscriber or authorized user to convert the indication of interest into the firm order; if the first subscriber or authorized user is authorized to submit the firm order, receiving authorization information, such as an agreement, from the first subscriber or authorized user, the authorization information being stored in the storage element; converting the indication of interest into the firm order; placing the firm order into an on-line trading marketplace; receiving a request from a second subscriber or authorized user to proceed with a transaction involving the firm order; and matching the second subscriber or authorized user to the firm order submitted by the first subscriber or authorized user to form a trade, and once matched the economic fee is due and payable by one of the first subscriber or authorized user or the second subscriber or authorized user independent of completion of the trade.

The present invention is also directed to, in a digital trading marketplace for trading interests in a company, a computer-implemented method of trading the interests comprising generating a window element having along one side a drop down menu list element having a plurality of menu items associated therewith; a plurality of window tab elements disposed in a row along a top portion of the window element; a button element disposed along the top portion of the window, the button element allowing a user to input an indication of interest in a selected company; and a left pane element and right pane element, where the right and left pane elements form part of the window. The left pane element displays on a display element messages associated with selected users of the trading marketplace, and the left pane element displays on a display information associated with each of the plurality of window tab elements.

The plurality of menu items of the drop down menu list element can include a first menu item element for displaying on a display when selected interests in companies to be traded in the digital trading marketplace, a second menu item element for displaying on the display information associated with a plurality of companies, and a third menu item element for displaying on the display information firm order information for use by personnel of the trading marketplace. The first menu list element includes a trading menu item element, the second meu item element includes a historical menu item element, and a third menu item element includes a staff menu item element. Further, the plurality of window tab elements comprise a first tab element for displaying trading activity associated with the trading marketplace. Still further, when the button element is selected, generating a user interface element for display in the window to allow a subscriber or authorized user to submit trading information associated with the selected company. Also, when selecting one of the plurality of menu items of the drop down menu list element, generating in the right pane element a plurality of second tab elements disposed in a row.

The present invention is also directed to a method comprising receiving an indication of an interest submitted by a first subscriber or authorized user for display on a user interface, where the indication of interest includes an interest in a private security; receiving a request to convert the indication of interest into a firm order from the first subscriber or authorized user, the firm order having an economic fee associated therewith; and requesting authorization information from the first subscriber or authorized user indicating that the first subscriber or authorized user is authorized to convert the indication of interest into a firm order. If the first subscriber or authorized user is authorized to submit the firm order, receiving authorization information from the first subscriber or authorized user, the authorization information being stored in the storage element; converting the indication of interest into the firm order; receiving a request from the second subscriber or authorized user to proceed with a transaction involving the firm order; and matching the second subscriber or authorized user to the firm order submitted by the first subscriber or authorized user to form a trade. Once matched, the economic fee is due and payable by one of the first subscriber or authorized user or the second subscriber or authorized user independent of completion of the trade.

Further, the present invention contemplates various combinations of the foregoing features or elements, and hence the invention is not to the currently recited steps or features.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1A is a schematic block diagram depicting an embodiment of a network environment comprising client devices in communication with servers through a network arrangement.

FIG. 1B is a schematic block diagram depicting a cloud computing environment that includes client devices in communication with a cloud service provider.

FIGS. 1C and 1D are schematic block diagrams depicting embodiments of computing devices useful for the methods and systems described herein.

FIG. 2 is a schematic block diagram illustrating the alternative trading system of the present invention.

FIG. 3 is a schematic block diagram illustrating the data analysis unit of the alternative trading system of the present invention.

FIGS. 4 and 5 are flow charts illustrating the operation of the alternative trading system of the present invention, including the execution of orders on the system.

FIG. 6 is a screen shot depiction of the trading system of the present invention illustrating the various information that can be displayed on a computing system implementing or accessing the trading system, and specifically showing financial metric information associated with a plurality of interests.

FIGS. 7A, 7B, and 7C are screen shot depictions of the trading system of the present invention illustrating the various information that can be displayed on a computing system implementing or accessing the trading system, and specifically showing the creation and submission of an indication of interest in a company.

FIG. 8 is a screen shot depiction of the trading system of the present invention illustrating the creation of an indication of interest in a company.

FIG. 9 is a screen shot depiction of the trading system of the present invention illustrating the creation of an indication of interest in a company, and specifically displaying the user interface element to convert the indication of interest into a firm order.

FIGS. 10A and 10B are screen shot depictions of the trading system of the present invention illustrating the conversion of an indication of interest in a company into a firm order.

FIG. 11 is a screen shot depiction of the trading system of the present invention illustrating the creation of a firm order in an interest in a company.

FIG. 12 is a screen shot depiction of the trading system of the present invention illustrating the information displayed in the window after creation of a firm order.

FIG. 13 is a screen shot depiction of the trading system of the present invention illustrating the information displayed in the window when the My Tickets tab element is selected.

FIG. 14 is a screen shot depiction of the trading system of the present invention illustrating the information displayed in the window when the Watchlist tab element is selected.

FIG. 15 is a screen shot depiction of the trading system of the present invention illustrating the information displayed in the window when the Historical drop down list item is selected.

FIGS. 16A and 16B are screen shot depictions of the trading system of the present invention illustrating the information displayed in the window when the Staff drop down list is selected, while also displaying the firm order information accessible by the trading system.

### DETAILED DESCRIPTION

Following below are more detailed descriptions of various concepts related to, and embodiments of, an alternative trading system (also generally referred to herein as an ATS, a trading system, a trading platform, or a trading marketplace) with firm orders and methods of accessing, employing, utilizing and executing firm orders on the trading platform. The trading system is an on-line, computerized or digital marketplace for trading securities by subscribers or authorized users. Alternatively, the trading of securities can be transacted directly between the subscribers or authorized users with the assistance of the trading system using various other communication tools and techniques, including digital communication techniques, such as electronic mail and the like. It should be appreciated that various concepts introduced above and discussed in greater detail below may be implemented in any number of ways, as the disclosed concepts are not limited to any particular manner of implementation. Examples of specific implementations and applications are provided below primarily for illustrative purposes and for providing or describing the operating environment of the alternative trading system of the present invention.

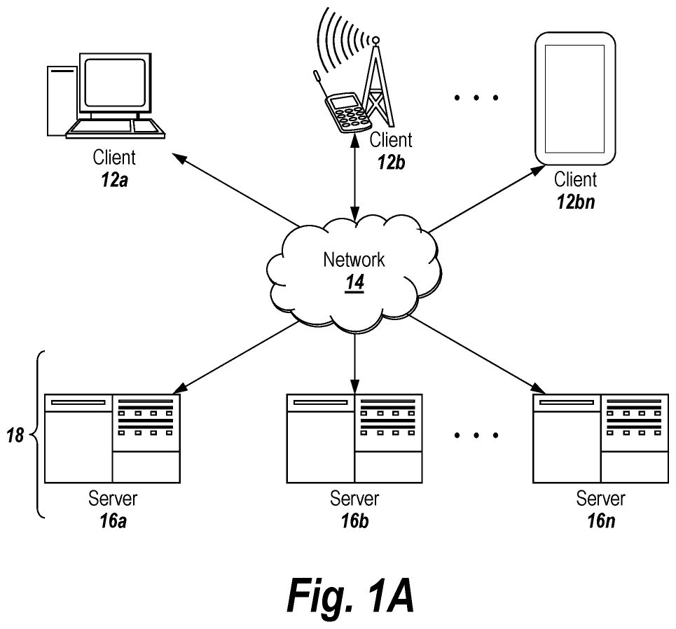

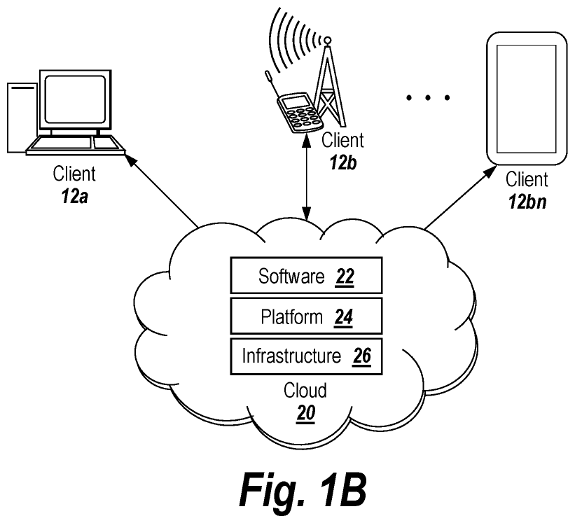

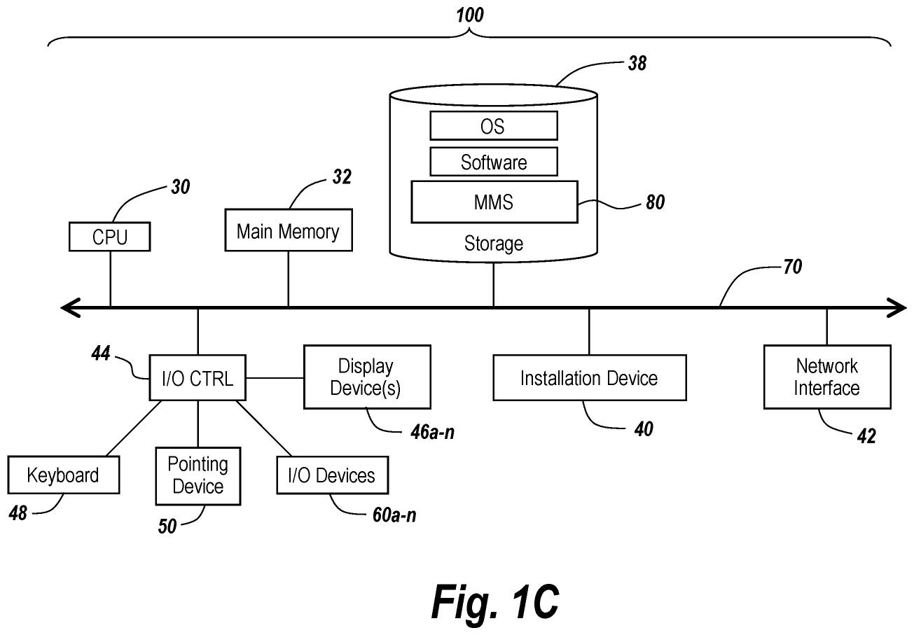

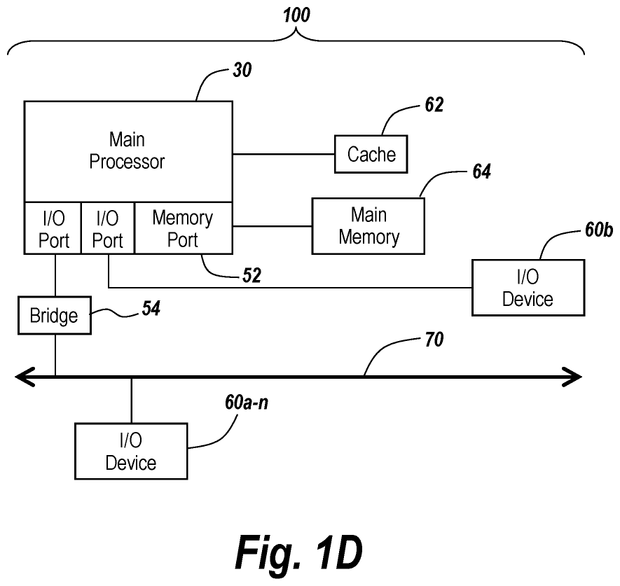

Prior to discussing specific inventive embodiments, it may be helpful to describe aspects of the operating environment as well as associated system components (e.g., hardware elements) in connection with the methods and systems described herein. Referring to FIG. 1A, an embodiment of a network environment is depicted. In brief overview, the illustrated exploring network environment includes one or more clients 12a-12n (also generally referred to as local machine(s) 12, client(s) 12, client node(s) 12, client machine(s) 12, client computer(s) 12, client device(s) 12, endpoint(s) 12, or endpoint node(s) 12) in communication with one or more servers 16a-16n (also generally referred to as server(s) 16, node 16, or remote machine(s) 16) via one or more networks 14. In some embodiments, a client 12 has the capacity to function as both a client node seeking access to resources provided by a server and as a server providing access to hosted resources for other clients 12a-12n. The clients can be any suitable electronic or computing device, including for example, a computer, a server, a smartphone, a smart electronic pad, a portable computer, and the like, such as the computing device 100. The alternate trading system of the present invention allows subscribers or authorized users to access the trading system through the client devices.

Although FIG. 1A shows a network 14 between the clients 12 and the servers 16, the clients 12 and the servers 16 may be on the same network 14. In some embodiments, there are multiple networks 14 between the clients 12 and the servers 16. In one of these embodiments, a network 14′ (not shown) may be a private network and a network 14 may be a public network. In another of these embodiments, a network 14 may be a private network and a network 14′ a public network. In still another of these embodiments, networks 14 and 14′ may both be private networks.

The network 14 may be connected via wired or wireless links. Wired links may include Digital Subscriber Line (DSL), coaxial cable lines, or optical fiber lines. The wireless links may include BLUETOOTH, Wi-Fi, NFC, RFID Worldwide Interoperability for Microwave Access (WiMAX), an infrared channel or satellite band. The wireless links may also include any cellular network standards used to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 14 may be any type and/or form of network. The geographical scope of the network 14 may vary widely and the network 14 can be a body area network (BAN), a personal area network (PAN), a local-area network (LAN), e.g. Intranet, a metropolitan area network (MAN), a wide area network (WAN), or the Internet. The topology of the network 14 may be of any form and may include, e.g., any of the following: point-to-point, bus, star, ring, mesh, or tree. The network 104 may be an overlay network, which is virtual and sits on top of one or more layers of other networks 14′. The network 14 may be of any such network topology as known to those ordinarily skilled in the art capable of supporting the operations described herein. The network 14 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 14 may be a type of a broadcast network, a telecommunications network, a data communication network, or a computer network.

In some embodiments, the network system may include multiple, logically-grouped servers 16. In one of these embodiments, the logical group of servers may be referred to as a server farm 18 or a machine farm 18. In another of these embodiments, the servers 16 may be geographically dispersed. In other embodiments, a machine farm 18 may be administered as a single entity. In still other embodiments, the machine farm 18 includes a plurality of machine farms 18. The servers 16 within each machine farm 18 can be heterogeneous, and one or more of the servers 16 or machines 16 can operate according to one type of operating system platform (e.g., WINDOWS NT, manufactured by Microsoft Corp. of Redmond, Wash.), while one or more of the other servers 16 can operate according to another type of operating system platform (e.g., Unix, Linux, or Mac OS X).

In one embodiment, servers 16 in the machine farm 18 may be stored in high-density rack systems, along with associated storage systems, and located in an enterprise data center. In this embodiment, consolidating the servers 16 in this way may improve system manageability, data security, the physical security of the system, and system performance by locating servers 16 and high performance storage systems on localized high performance networks. Centralizing the servers 16 and storage systems and coupling them with advanced system management tools allows more efficient use of server resources.

The servers 16 of each machine farm 18 do not need to be physically proximate to another server 16 in the same machine farm 18. Thus, the group of servers 16 logically grouped as a machine farm 18 may be interconnected using a wide-area network (WAN) connection or a metropolitan-area network (MAN) connection. For example, a machine farm 18 may include servers 16 physically located in different continents or different regions of a continent, country, state, city, campus, or room. Data transmission speeds between servers 16 in the machine farm 18 can be increased if the servers 16 are connected using a local-area network (LAN) connection or some form of direct connection. Additionally, a heterogeneous machine farm 18 may include one or more servers 16 operating according to a type of operating system, while one or more other servers 16 execute one or more types of hypervisors rather than operating systems. In these embodiments, hypervisors may be used to emulate virtual hardware, partition physical hardware, virtualized physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 18 may be de-centralized. For example, one or more servers 16 may comprise components, subsystems and modules to support one or more management services for the machine farm 18. In one of these embodiments, one or more servers 16 provide functionality for management of dynamic data, including techniques for handling failover, data replication, and increasing the robustness of the machine farm 18. Each server 16 may communicate with a persistent store and, in some embodiments, with a dynamic store.

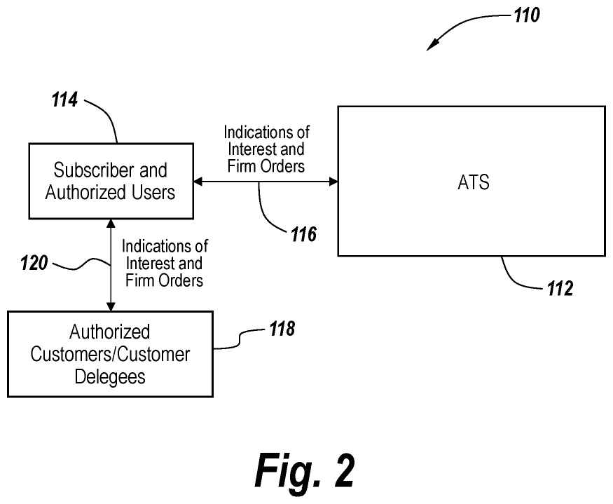

Server 16 may be a file server, application server, web server, proxy server, appliance, network appliance, gateway, gateway server, virtualization server, deployment server, SSL VPN server, or firewall, or any other suitable computing device, such as computing device 100. In one embodiment, the server 16 may be referred to as a remote machine or a node. In another embodiment, a plurality of nodes may be in the path between any two communicating servers. The alternative trading system 112, FIG. 2, of the present invention can be stored on one or more of the servers 16, and the hardware associated with the server, such as the processor or CPU 30 and 36 and memory 33, 38, and 64 can be employed.

Referring to FIG. 1B, a cloud computing environment is depicted. A cloud computing environment may provide clients 12 with one or more resources provided by a network environment. The cloud computing environment may include one or more clients 12a-12n, in communication with the cloud 20 over one or more networks, an illustrative example of which is network 14. Clients 12 may include, e.g., thick clients, thin clients, and zero clients. A thick client may provide at least some functionality even when disconnected from the cloud 20 or servers 16. A thin client or a zero client may depend on the connection to the cloud 20 or server 16 to provide functionality. A zero client may depend on the cloud 20 or other networks 14 or servers 16 to retrieve operating system data for the client device. The cloud 20 may include back end platforms, e.g., servers 16, storage, server farms or data centers.

The cloud 20 may be public, private, or a hybrid of both. Public clouds may include public servers 16 that are maintained by third parties to the clients 12 or the owners of the clients. The servers 16 may be located off-site in remote geographical locations as disclosed above or otherwise. Public clouds may be connected to the servers 16 over a public network. Private clouds may include private servers 16 that are physically maintained by clients 12 or owners of clients. Private clouds may be connected to the servers 16 over a private network 14. Hybrid clouds 20 may include both the private and public networks 14 and servers 16. The alternative trading system 112 of the present invention can also be implemented in the cloud 20, and hence would be stored as software 22, and utilize the platform 24 and infrastructure 26 of the cloud 20, as well as one or more components of the computing device 100.

The cloud 20 may also include a cloud based delivery, e.g. Software as a Service (Saas) 22, Platform as a Service (PaaS) 24, and Infrastructure as a Service (IaaS) 26. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 12 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 12 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby. WSGI for Python, or PSGI for Perl, or other APIs that may be built on REST, HTTP. XML, or other protocols. Clients 12 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 12 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 12 and server 16 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 12 and/or a server 16. As shown in FIGS. 1C and 1D, each computing device 100 includes a central processing unit 30, and a main memory unit 34. As shown in FIG. 1C, a computing device 100 may include a storage device 38, an installation device 40, a network interface 42, an I/O controller 44, display devices 46a-46n, a keyboard 48 and a pointing device 50, e.g. a mouse. The storage device 38 may include, without limitation, an operating system, and/or software of an alternative trading system (e.g., the alternative trading system 110 described herein). As shown in FIG. 1D, each computing device 100 may also include additional optional elements, e.g. a memory port 52, a bridge 54, one or more input/output devices 60a-60n (generally referred to using reference numeral 60), and a cache memory 62 in communication with the central processing unit 30.

The central processing unit 30 is any logic circuitry that responds to and processes instructions fetched from the main memory unit 64. In many embodiments, the central processing unit 30 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 30 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 64 may include one or more memory chips capable of storing data and allowing any storage location to be directly accessed by the microprocessor 30. Main memory unit 64 may be volatile and faster than memory of the storage unit 38. Main memory units 64 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 64 or the storage 38 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 64 may be based on any of the above described memory chips, or any other available memory chips capable of operating as described herein. In the embodiment shown in FIG. 1C, the processor 30 communicates with main memory 32 via a system bus 70 (described in more detail below). FIG. 1D depicts an embodiment of a computing device 100 in which the processor communicates directly with main memory 64 via a memory port 52. For example, in FIG. 1D the main memory 64 may be DRDRAM.

FIG. 1D depicts an embodiment in which the main processor 30 communicates directly with cache memory 62 via a secondary bus, sometimes referred to as a backside bus. In other embodiments, the main processor 30 communicates with cache memory 62 using the system bus 70. Cache memory 62 typically has a faster response time than main memory 64 and is typically provided by SRAM, B SRAM, or EDRAM. In the embodiment shown in FIG. 1D, the processor 30 communicates with various I/O devices 60 via a local system bus 70. Various buses may be used to connect the central processing unit 30 to any of the I/O devices 60, including a PCI bus, a PCI-X bus, or a PCI-Express bus, or a NuBus. For embodiments in which the I/O device is a video display 46, the processor 30 may use an Advanced Graphics Port (AGP) to communicate with the display 46 or the I/O controller 44 for the display 46. FIG. 1D depicts an embodiment of a computer 100 in which the main processor 30 communicates directly with I/O device 60b or other processors 30 via HYPERTRANSPORT, RAPIDIO, or INFINIBAND communications technology. FIG. 1D also depicts an embodiment in which local busses and direct communication are mixed: the processor 30 communicates with I/O device 60a using a local interconnect bus while communicating with I/O device 60b directly.

A wide variety of I/O devices 60a-60n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 60a-60n may include a combination of multiple input or output devices, including, e.g., Microsoft KINECT, Nintendo Wiimote for the WII, Nintendo WII U GAMEPAD, or Apple IPHONE. Some devices 60a-60n allow gesture recognition inputs through combining some of the inputs and outputs. Some devices 60a-60n provides for facial recognition which may be utilized as an input for different purposes including authentication and other commands. Some devices 60a-60n provides for voice recognition and inputs, including, e.g., Microsoft KINECT, SIRI for IPHONE by Apple, Google Now or Google Voice Search.

Additional devices 60a-60n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXEL SENSE or Multi-Touch Collaboration Wall, may have larger surfaces, such as on a table-top or on a wall, and may also interact with other electronic devices. Some I/O devices 60a-60n, display devices 46a-46n or group of devices may be augment reality devices. The I/O devices may be controlled by an I/O controller 44 as shown in FIG. 1C. The I/O controller may control one or more I/O devices, such as, e.g., a keyboard 48 and a pointing device 50, e.g., a mouse or optical pen. Furthermore, an I/O device may also provide storage and/or an installation medium 40 for the computing device 100. In still other embodiments, the computing device 100 may provide USB connections (not shown) to receive handheld USB storage devices. In further embodiments, an I/O device 60 may be a bridge between the system bus 70 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 46a-46n may be connected to I/O controller 44. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 46a-46n may also be a head-mounted display (HMD). In some embodiments, display devices 46a-46n or the corresponding I/O controllers 44 may be controlled through or have hardware support for OPENGL or DIRECTX API or other graphics libraries.

In some embodiments, the computing device 100 may include or connect to multiple display devices 46a-46n, which each may be of the same or different type and/or form. As such, any of the I/O devices 60a-60n and/or the I/O controller 44 may include any type and/or form of suitable hardware, software, or combination of hardware and software to support, enable or provide for the connection and use of multiple display devices 46a-46n by the computing device 100. For example, the computing device 100 may include any type and/or form of video adapter, video card, driver, and/or library to interface, communicate, connect or otherwise use the display devices 46a-46n. In one embodiment, a video adapter may include multiple connectors to interface to multiple display devices 46a-46n. In other embodiments, the computing device 100 may include multiple video adapters, with each video adapter connected to one or more of the display devices 46a-46n. In some embodiments, any portion of the operating system of the computing device 100 may be configured for using multiple displays 46a-46n. In other embodiments, one or more of the display devices 46a-46n may be provided by one or more other computing devices 100a or 100b connected to the computing device 100, via the network 14. In some embodiments software may be designed and constructed to use another computer's display device as a second display device 46a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 46a-46n.

Referring again to FIG. 1C, the computing device 100 may comprise a storage device 38 (e.g. one or more hard disk drives or redundant arrays of independent disks) for storing an operating system or other related software, and for storing application software programs such as any program related to the software 80 for the alternative trading system of the present invention. Examples of storage devices 38 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. The storage device 38 may be non-volatile, mutable, or read-only. The storage device 38 may be internal and connect to the computing device 100 via a bus 70. Further, the storage device 38 may be external and connect to the computing device 100 via an I/O device 60 that provides an external bus. Some storage devices 38 may connect to the computing device 100 via the network interface 42 over a network 14, including, e.g., the Remote Disk for MACBOOK AIR by Apple. Some client devices 12 may not require a non-volatile storage device 38 and may be thin clients or zero clients 12. The storage device 38 may also be used as an installation device 40, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

The computing device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 12. An application distribution platform may include a repository of applications on a server 16 or a cloud 20, which the clients 12a-12n may access over a network 14. An application distribution platform may include application developed and provided by various developers. A user of a client device 12 may select, purchase and/or download an application via the application distribution platform.

Furthermore, the computing device 100 may include a network interface 42 to interface to the network 14 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 42 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

The computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOK S.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com. Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the computing device 100 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the computing device 100 is a laptop or desktop computer equipped with a web browser and a microphone and speaker system, e.g. a telephony headset. In these embodiments, the computing devices 100 are web-enabled and can receive and initiate phone calls. In some embodiments, a laptop or a desktop computer is also equipped with a webcam or other video capture device that enables video chat and video call. In some embodiments, the computing device 100 is a wearable mobile computing device including but not limited to Google Glass and Samsung Gear.

In some embodiments, the status of one or more machines 12, 16 in the network 14 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the alternative trading system disclosed herein.

The present invention is directed to an alternative trading system that allows subscribers and/or authorized users operating as buyers and sellers of selected interests to trade (i.e., sell, buy, or swap) the interests thereon. The ATS allows subscribers and authorized users to generate and/or execute selected documentation to bind the parties, as part of firm buy and/or firm sell orders (e.g., firm orders), to purchase and sell the interests. The trading system of the present invention and associated firm orders are further shown in FIGS. 2 through 16B.

Participation on the trading system is open to any entity regulated by a federal functional regulatory agency, such as for example the U.S. Securities and Exchange Commission (SEC), the Commodity Futures Trading Commission, or the Federal Reserve or comparable foreign regulators, such as for example the U.K. Financial Conduct Authority, the Financial Services Agency of Japan, and the like. These entities are deemed to be subscribers to the trading system. Participation in or on the trading system can also be open to authorized users of the trading system. The authorized users can include (i) authorized registered representatives of a subscriber (Authorized Registered Representatives); (ii) any person or entity that is a customer sponsored by a subscriber (Authorized Customers); and (iii) authorized customers' authorized delegees (Authorized Customer Delegees). According to one practice, the authorized customers and authorized customer delegees can submit all indications of interest and orders for transactions on the trading system to a subscriber for approval and posting to the trading system. The authorized customers may be authorized by multiple subscribers to submit indications of interest and orders to the trading system and, as a result, such authorized customers can designate the sponsoring subscriber for each indication of interest and order submitted to the trading system. The subscribers, representing their own interests or those of their authorized customers who are potential buyers and sellers, place data on the ATS about potential transactions involving interests. The subscribers and/or authorized users are generally referred to herein as clients, users, subscribers, or authorized users. As used herein, the term “interest” or “interests” can include any tradeable asset including for example public or private securities of domestic and foreign companies, limited partnerships, limited liability companies, and other comparable entities, domestic and foreign, that may potentially be available for purchase or sale through the trading system. The asset may be traded on the trading system by a subscriber and/or authorized user offering to sell the asset, purchase the asset, or swap the asset. In private markets, private securities can be traded by the subscribers and the authorized users without the use of a central clearing house.

General summary information on the interests can be displayed to selected subscribers that have been designated via selected data analytics metrics as qualified to review particular categories of investment opportunities and to any authorized users any such subscriber designates as appropriate. Data analytics metrics determinations, such as via the data analysis unit 124, are based upon such factors as a subscriber's or authorized user's stated preferences for investment, including, but not limited to, industry, size of transaction, business history of issuer and its principals and the like, past history of interest in reviewing particular classes of investments, and financial ability. Subscribers and authorized users have the ability to view general summary information regarding the types of interests available to them on the trading system and then can request access to additional levels of information about selected interests. The trading system thus enables subscribers, on behalf of themselves and their authorized users, to post indications of interest or orders in the interests they wish to buy or sell while maintaining the level of anonymity they desire until all parties have agreed to disclose their or their clients' identities.

A subscriber or authorized user can view any anonymous investment profile available to it on the trading system, and such subscriber or authorized user can view additional information such as additional deal summary information in the applicable data room on the trading system by, for example, clicking on the designated soft button(s) in a user interface to request access. By accepting or denying such requests, the posting subscriber that is seeking an order to buy or sell an interest can have full control over the subscribers and authorized users it permits to access the additional information. Subscribers with additional information access granted can then distribute that information to their authorized users deemed suitable and can maintain the level of anonymity desired until all parties have agreed to disclose their clients' identities.

Once a subscriber or authorized user has been granted access to the trading system, the subscriber can have access to the trading system through any known security protocol or type, such as, for example, via a password protected electronic link. Each subscriber can deliver to the trading system and keep current a list of authorized users, such as authorized registered representatives and authorized customers and authorized customer delegees that are authorized users permitted to access information posted on the trading system. Subscribers and authorized users can be prompted to supply a password prior to accessing the site. Password permissioning and depermissioning of authorized users, can be if desired, the responsibility of the sponsoring subscriber. Indications of interest in and orders with respect to buying or selling any given interest can be posted to the trading system on behalf of an authorized customer through the authorized customer's sponsoring subscriber. Such posting can be viewed, if desired, by authorized users approved to see such posting by the system operator, the sponsoring subscriber and its authorized customer.

Although the trading system of the present invention can be employed to trade (i.e., buy, sell or swap) any selected type of interest, according to one practice of the present invention the trading system can be configured to trade private securities. As used herein, “private security” or “private securities” is intended to include a security or securities that are not registered under the Securities Act of 1933, as amended (Securities Act) or the Securities Exchange Act of 1934, as amended (Exchange Act) and that are not listed on a registered national securities exchange such as the New York Stock Exchange or Nasdaq. The security can be a fungible, frequently negotiable, financial instrument that holds some type of value. Examples of securities include bonds, debentures, notes, options, shares (i.e., stocks), and warrants. The trading system can facilitate trades in private securities across various sectors and forms of securities, both domestic and foreign. The securities traded on the trading system may be, for example, in the form of limited partnership interests, interests in limited liability companies, or other types of interests, including interests in corporations. Transactions executed through the trading system that are subject to U.S. federal securities laws can be executed under one or more exemptions from registration under the Securities Act.

The trading system of the present invention can have a network configuration such as shown in FIG. 1A, and the software implementing the trading system of the present invention can be stored on one or more of the servers 16a-16n, or can be distributed across the illustrated network system. In this configuration, the subscribers and the authorized users can access the trading system via one or more of the client devices 12a-12n. Alternatively, the trading system of the present invention can be a cloud-based software and hardware platform that interconnects subscribers that have entered into a subscriber agreement with the system and have been approved to access the trading system. An example of the cloud based storage and operation of the trading system is shown in FIG. 1B. In this embodiment, the trading system software can be identified as the software layer 22 that utilizes and employs the hardware elements of the cloud 20, such as the platform 24 and the infrastructure 26. The cloud 20 can employ resources, such as computing device 100, within the cloud environment 20. The computing device 100 can be structured as illustrated in FIG. 1C and FIG. 1D. In the cloud 20, the trading system can be housed in any suitable secured environment and implemented across a distributed network. As is known, the data centers of the cloud 20 can employ manned surveillance, video cameras, and intrusion detection systems to monitor the exterior and interior of all facilities. Access into the data center can also requires authorized staff to pass two-factor authentication at least twice to access data center floors.

The transactions executed through the trading system of the present invention need not involve securities that are centrally cleared, but rather are cleared and settled by the parties to the transaction by means of suitable closing documents agreed to by the parties. Transactions posted on the trading system are executed and cleared as follows: each of the subscribers representing the buyer and the seller have executed the subscriber agreement, and the subscriber and/or the authorized users (e.g., clients of the subscriber) in the case of a proprietary trade also execute the closing documents. The system can be configured so as not to receive or hold customer funds or securities. The clearance and settlement by subscribers are subject to the policies and approvals of such subscribers.

Transactions conducted on or in conjunction with the trading system are subject to an economic fee for use of the trading system, in the form of a commission or broker fee on closed transactions, payable by one or more of the parties to the transaction (herein generally referred to as a fee, monetary fee, an economic fee, a broker fee, a brokerage fee, or a penalty). The economic fee can be shared or split in any suitable manner between any suitable parties. For example, the economic fee can be split between one or more of the subscribers and/or authorized users who are acting as brokers to the transaction and the broker or operator that operates the trading system. The orders from the subscribers may be entered as either indications of interest or firm orders. As used herein, “indication of interest” or “indications of interest” are intended to include at least initially non-binding indications of an interest in a tradeable asset of a company. The indications of interest can include indications from a subscriber or authorized user of an intent to trade an interest, such as a security. The interest is typically non-binding, but can also include an indication to proceed, pending verification and authorization, of a binding intent to proceed with a transaction via a request for a firm order. Hence, until verified and/or approved, the request for a firm order is non-binding, and hence is still an indication of interest. Since the indications of interest are non-binding, the seller and/or purchaser of the asset or interest can elect not to complete the transaction without paying any economic fee. The indications of interest can be entered by the subscriber or authorized user into the trading system as described below via the various interfaces, or the indications of interest can be entered via personnel of the trading system into the system. All of these scenarios are contemplated by the present invention.

As used herein “firm order” or “firm orders” is intended to include binding indications of an interest in a tradeable asset of a company. The tradeable assets typically include securities, such as the stock of a company. Since the indications are binding, the seller and/or purchaser of the asset are required to pay the economic fee even if the seller and/or buyer of the asset elect not to complete the transaction. Thus, according to the present invention, a subscriber or authorized user entering an indication of interest in the trading system of the present invention may cancel the trade at any time before signing a stock transfer agreement without penalty or payment of the economic fee. However, when the indication of interest is converted into a firm order, such as for example upon receipt of a request for a firm order and upon receipt of the requisite authorization information, the posting subscriber according to the teachings of the present invention may still cancel a proposed trade at any time on the trading system before a counterparty has been identified without penalty. However, once a counterparty to the trade has been identified, the subscriber or authorized user is contractually obligated to either close the trade on the terms specified in the firm order or pay the economic fee. The economic fee can be for example an investment banking or brokerage fee equal to the commission that would have been payable for a closed trade. The firm order is thus a binding obligation on the subscriber and/or authorized user to pay such fee and hence forms part of the present invention. One of ordinary skill in the art will readily recognize in light of the teachings herein that the firm order can be either a firm buy order or a firm sell order, depending upon whether the applicable subscriber or authorized user has indicated their desire to sell an interest or buy an interest.

The trading system 112 of the present invention thus enables a potential buyer and a potential seller that would like to move forward with a proposed transaction, have reached agreement on the price and payment particulars, and have been authorized by their sponsoring subscribers, to use the trading system to electronically execute and upload documentation for listing an indication of interest that can be converted into a firm order, thus making the commitment firm and binding. Once the buyer and seller agree to execute the transaction, the terms of the trade are memorialized in the closing documentation and the parties are now obligated to complete the transaction. The system enables all interactions between buyers and sellers to be reviewed by the sponsoring subscribers. Further, the system of the present invention enables the buyers and sellers to negotiate directly to determine all terms and conditions for the transaction, as well as clearance and settlement particulars. Optionally, the system can include suitable auction based functionality in order to implement an auction process onto the trading system. As noted above, since the transactions executed through the trading system may involve transfers of interests, such as private securities, that are not registered under the Securities Act and that are not centrally cleared and settled, the subscribers and the authorized users can clear and settle the transactions pursuant to the closing documents. Each subscriber is responsible for clearance and settlement of trades resulting from orders submitted by that subscriber for itself and on behalf of its authorized user customers.

The trading system 112 allows subscribers and authorized users to view general information regarding the interests available to them on the system, preferably without the issuer being identified. This first general level of information, which may be partially or fully anonymized based on the circumstances of the trade, can be a very brief description of the industry and type of interest and whether the proposed trade is to buy or sell an interest (e.g., stock). A subscriber or authorized user may then request access to the trading system through a client device 12 to gain access to a second level of general information that contains additional summary information about the interests, such as summary of investment terms and high level information regarding the issuer of interests (e.g., industry, location and summary description of business). Finally, the subscriber or authorized user may request access in the trading system to an applicable data room to acquire additional information regarding the proposed trade. Following a review by the sponsoring subscriber, the authorized user seeking access to the data room can be granted or denied access. The trading system can set for each specific situation the point at which a party is de-anonymized, depending on the requirements of each of the parties. The data room preferably contains customary due diligence documents, but the actual contents can be determined by the party providing the documents to the data room. Publicly available information on selected private companies that has been aggregated by third parties can also be available on the ATS to all subscribers and authorized users.

The trading system can enable subscribers, on behalf of themselves and their authorized customers, to initially post indications of interest, which are non-binding which can be subsequently converted into firm orders, in respect of selected interests while maintaining the level of anonymity they desire until all parties have agreed to disclose their or their clients' identities. The authorized users may use various third party order management systems or a Financial Information exchange (FIX) connection to communicate indications of interest and firm orders to their designated subscriber and such subscriber may use an order management system or FIX connection to communicate indications of interest and firm orders to the trading system.

The indications of interest with respect to buying or selling any given interest may be posted to the trading system on behalf of an authorized customer through the sponsoring subscriber. Such posting is available to be viewed by the authorized users approved to see such posting by the trading system, the sponsoring subscriber or the authorized customer on whose behalf the posting was made by the sponsoring subscriber. According to the present invention, the requests for access to view additional general information and/or to the data room are nonbinding and do not constitute a formal indication of interest. Requests for information are generally meant to evaluate the potential attractiveness of interests.

At the completion of a potential buyer's diligence process, the buyer may negotiate with the seller offline or use messaging tools within the trading system. If an agreement is reached the parties may electronically sign such closing documentation as the parties agree upon within the trading system or may exchange closing documents by any other method the parties to the transaction agree upon. The trading system does not accept customer deposits. The exchange of money and interests in connection with closing transactions can be effected through a suitable third party, such as a bank or an escrow agent. When a proposed transaction is closed, to remove the posting from the ATS, the posting party clicks a button that indicates that the transaction should be moved to closed transactions and the ATS then so moves the transaction.

According to one practice of the present invention, in order to gain access to the trading system a potential subscriber can submit selected identifying data, including name, email address, organization type, and a list of its principal officers, owners and directors and other information as required by the system. Once approved for access to the system, the subscriber executes a subscriber agreement. Once a subscriber has been granted access to the trading system, the subscriber can access the trading system via a password protected electronic link. Each subscriber can deliver to the system and keep current a list of its authorized registered representatives, authorized customers and authorized customer delegees that are authorized users permitted to access information posted on the trading system. The subscribers and the authorized users can be prompted to supply a password prior to accessing the site. As such, and according to an illustrative embodiment, the system is configured to ensure that only authorized registered representatives may place orders on the ATS.

The trading system of the present invention, when hosted in the cloud 20, can be, for example, run in an active-active, highly available system cluster, with failover systems spread across availability zones, each designed as an independent failure zone. Failure handling scenarios and automated transfer of operation of the trading system are documented and checked in each major release of the trading system prior to deployment in the production operations environment. The system can employ multiple levels of redundancy to provide for business continuity in the event of a significant business disruption. The first level of protection is in the two availability zones, where all hardware components and software configurations are duplicated. The trading system can also be employ in the cloud environment (FIG. 1B) or in the network configuration (FIG. 1A) and can employ redundant servers, network infrastructure and disk storage so that no single failure will stop processing in the main sites and that any such failure is not visible to the user. Database servers and application servers are maintained separately such that failure of the application does not affect the uptime of the database. If a database server should fail, all queries can be immediately and automatically re-routed to the alternate, identical database server for continuity while the failed database server is restored. Similarly, should an application server fail, all traffic can be immediately and automatically re-routed to the alternate, identical application server for continuity while the failed application server is restored. Any server is independently capable of serving all traffic to the trading system.

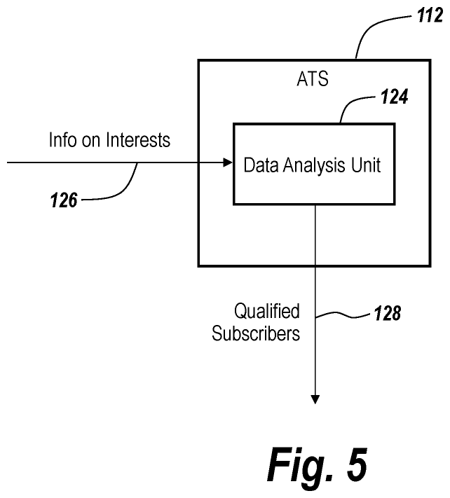

As illustrated in FIGS. 2 and 5, the system 110 of the present invention includes an alternate trading system 112 that can be implemented in the hardware environments illustrated in FIGS. 1A-1D. The trading system 112 can communicate with one or more subscribers and/or authorized users 114 via any suitable client device 12 or through any suitable computing device 100 for placing indications of interest or firm order requests 116 with the trading system 112. The subscriber 114 can communicate with authorized customers or delegees 118. The authorized customers 118 can likewise communicate indications of interest and firm orders 120 with the subscribers 114.

Further, the illustrated alternative trading system 112 can include a data analytics unit 124. The illustrated data analytics unit 124 can be implemented in hardware in one or more computing devices 100 implemented, for example, as one or more servers 16. The data analytics unit thus includes processing or CPU capabilities for analyzing and if desired storing data. The trading system 112 and specifically the data analytics unit 124 receives information or data of an interest 126 presented to the trading system 112 by one or more subscribers and/or authorized users via a client device 12. The subscribers, representing their own interests or those of their authorized customers who are potential buyers and sellers, place data on the trading system about potential transactions involving interests. The data analytics unit 124 then generates a set or list of qualified subscribers and/or authorized users 128 that are qualified or selected to view or display the information on the specific interests. The summary information on the interests can be displayed to selected subscribers on the client device 12 via a display element (e.g., display element 46) that have been designated via selected data analytics metrics as qualified to review particular categories of investment opportunities and to any authorized users and any such subscriber designates as appropriate. The data analytic metrics determinations can be based on a number of factors, including for example factors such as a subscriber's or authorized user's stated preferences for investment, including, but not limited to, industry, size of transaction, business history of issuer and its principals and the like, past history of interest in reviewing particular classes of investments, and financial ability. As such, the subscribers and authorized users have the ability to view general summary information regarding the types of interests available to them on the trading system and then can request access to additional levels of information about selected interests. The trading system thus enables subscribers to post indications of interest or firm orders in the interests they wish to trade while maintaining the level of anonymity they desire until all parties have agreed to disclose their or their clients' identities.

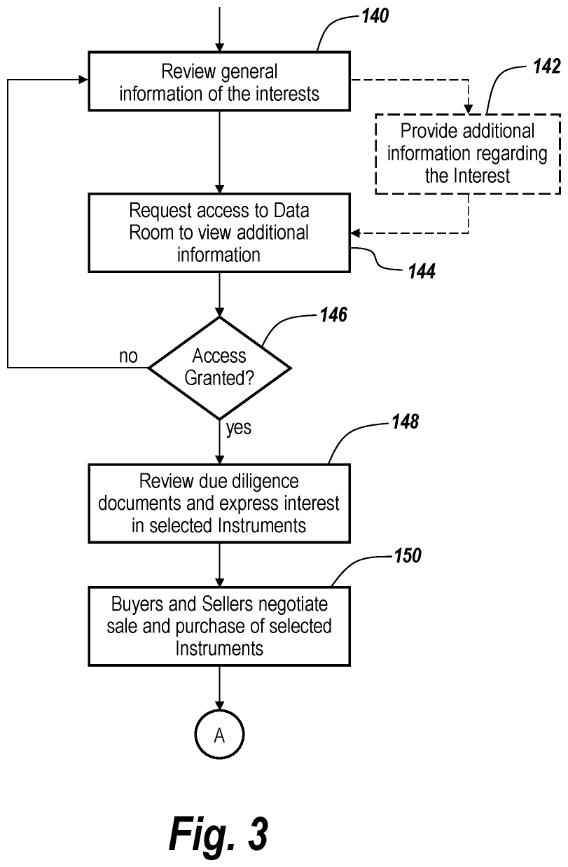

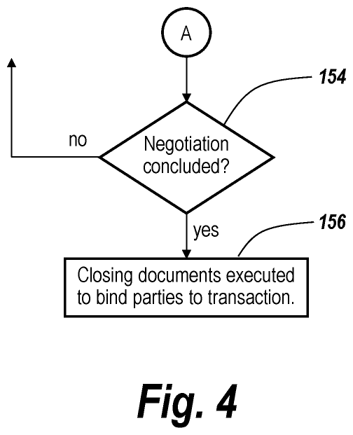

FIGS. 3 and 4 illustrate the method of the present invention whereby subscribers and authorized users gain access to information involving interests via the alternative trading system 112. The information provided through the trading system allows the subscribers to determine if they wish to proceed with an indication of interest in a specific interest. The subscriber can also decide that they wish to proceed with converting the indication of interest into a firm order (e.g., binding) on the specific or selected interest, thus obligating the parties to proceed with the transaction. If either party decides to renege on the deal, then the broker via the trading system is still entitled to the economic fee (e.g., brokerage fee). As shown in FIG. 3, the trading system 112 allows the subscribers and the authorized users to view general information regarding the interests available to them on the trading system, preferably without the issuer being identified. This optional first or initial general level of information, which may be partially or fully anonymized based on the circumstances of the trade, can be a very brief description of the industry and type of interest and whether the proposed trade is to buy or sell, step 140. The subscriber or authorized user is preferably a qualified subscriber as determined by the data analytics unit 124.

The subscriber or authorized user may then request access to an optional second level of general information that contains additional summary information about the interests, such as summary of investment terms and high level information regarding the issuer of interests (e.g., industry, location and summary description of business), step 142. After reviewing the information provided by the trading system 112, the subscriber or authorized user may request entrance into the applicable data room of the system for additional information regarding the proposed trade, step 144. Following review, the subscriber or the authorized user seeking access to the data room can be granted or denied access. As shown in FIG. 3, if the subscriber or authorized user is denied access to the data room, typically because they are not qualified to review the specific information contained therein, the trading system prevents them from accessing the particular documents in the data room. If the subscribing party is granted access, then the subscriber or authorized user can review the additional information contained therein, which includes additional due diligence documents. The trading system can set for each specific situation the point at which a party is de-anonymized, depending on the requirements of each of the parties. The data room preferably contains customary due diligence documents, but the actual contents can be determined by the party providing the documents. Publicly available information on selected private companies that has been aggregated by third parties can also be available on the trading system to all subscribers and authorized users.

The subscribers, on behalf of themselves and their authorized customers, can then access the trading system to post indications of interest in respect of selected interests while maintaining the level of anonymity they desire until all parties have agreed to disclose their or their clients' identities, step 148. The authorized users may use various third party order management systems or a FIX communications protocol connection to communicate indications of interest and eventually firm orders to their designated subscriber and such subscriber may use an order management system or the FIX connection to communicate indications of interest and firm orders to the trading system 112.

The indications of interest, which includes requests for firm orders and which involves buying or selling a given interest, may be posted to the trading system on behalf of an authorized customer through the sponsoring subscriber. Such posting is available to be viewed by the subscriber or authorized user approved to see such posting by the data analysis unit 124 of the trading system 112. At the completion of a subscribers diligence process, the subscriber, acting as a buyer, may negotiate with another subscriber, acting as a seller, either through the trading system 112, offline, or use messaging tools within the trading system, steps 148 and 150. If an agreement is reached, the parties may electronically sign such closing documentation as the parties agree upon within the trading system 112, or the parties may exchange closing documents by any other method independent of the trading system or in conjunction with the system that the parties to the transaction agree upon, step 156. When a proposed transaction is closed, to remove the posting from the trading system, the posting party can indicate that the transaction is closed. If the transaction is not completed, then the subscriber can review other interests posted in the trading system 112, step 148.

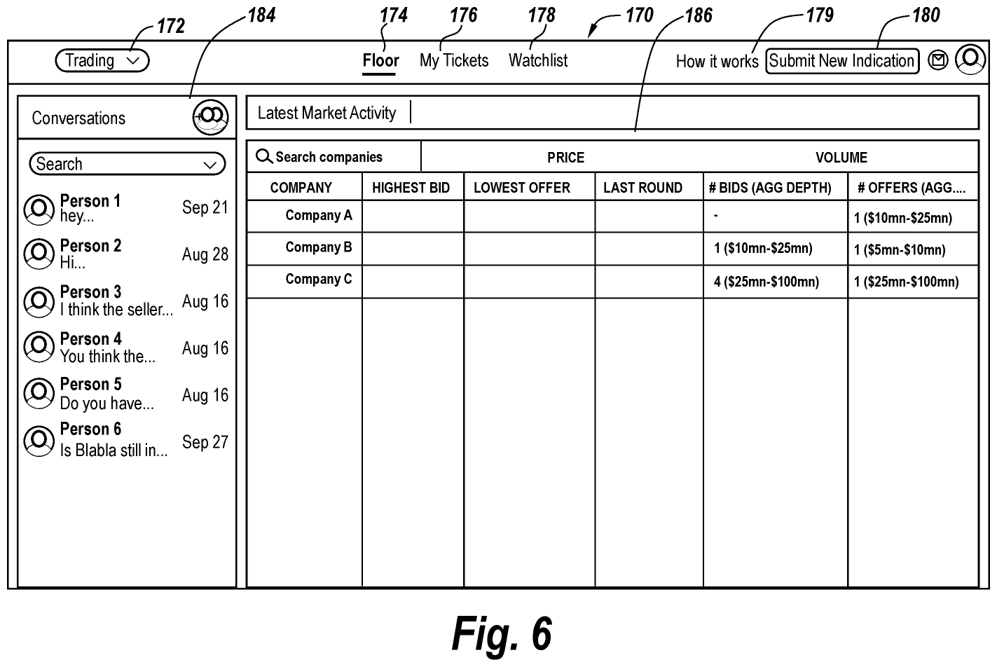

FIGS. 6 through 16B depict exemplary interfaces implemented by the alternative trading system 112 of the present invention. The interfaces can be displayed for example by the display device 46 of the computing device 100, which includes for example the client devices 12. The subscriber or authorized user can access the alternative trading system 112 that is stored for example in memory 32, 38, 64 of the computing device and implemented via the servers 16 using a client device 12.

FIG. 6 in particular illustrates a screen shot showing an initial window 170 (herein generally referred to as a window, a frame or a page). In the window 170, along a top portion thereof is a drop down list element 172 that has multiple lists associated therewith. The current list element is a trading element 172A. The top portion of the window 170 can also include one or more embedded tab elements, such as for example tab element 174 illustrated as a Floor tab, tab element 176 illustrated as My Tickets tab element, and tab element 178 illustrated as a Watchlist tab element. The Floor tab element 174 shows in selected panes of the window 170 information associated with selected interests on the trading platform. The My Tickets tab element 176 shows information associated with interests that a specific subscriber or authorized user are associated with, and the Watchlist tab element 178 shows information associated with interests that the subscriber or authorized user wish to monitor or track. The top portion of the window 170 also includes one or more soft buttons, including a How it works button element 179 for providing information about interests on the trading system 112, and a Submit New Indication button element 180 for allowing the system user (e.g., a subscriber or authorized user) to submit or indicate a general interest in one or more interests on the platform.

The window 170 also includes a left pane or frame element 184 and a right pane or frame element 186. The left and right pane elements 184, 186 can be constructed to display information associated with the platform. According to one embodiment, the left pane element 184 displays identification information about selected users on the trading platform. The trading system 112 can be configured such that the identified users form part of a financial network of contacts that each user can be connected with according to known techniques. The left pane element 184 also allows each user listed therein to message each other while on the trading system 112. The left pane element 184 can include a search box for searching for selected users. The right pane element 186 lists selected information about interests that are currently being traded on the trading system. For example, the right pane element 186 can include the name of the company, the bid and offer price metrics associated with the interests (e.g., stocks) being traded on the platform, as well as other selected information, including the number of bids and offers associated with each interest. Other types of information can also be displayed, including the share volume and volume range of each interest. The right pane element 186 can also include a search box for searching selected companies for ease of navigation on the platform or system.

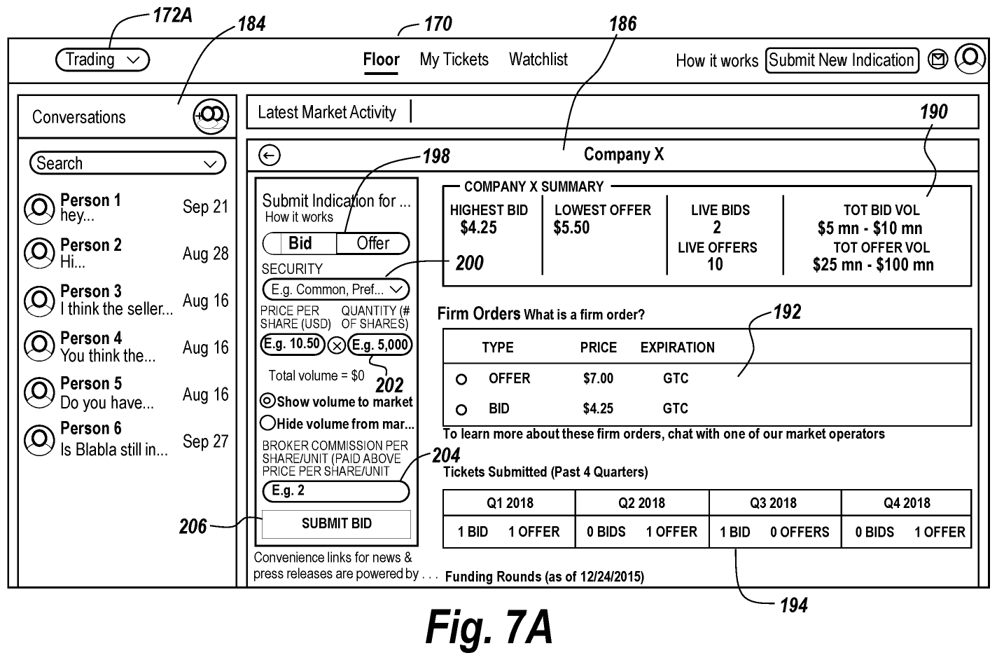

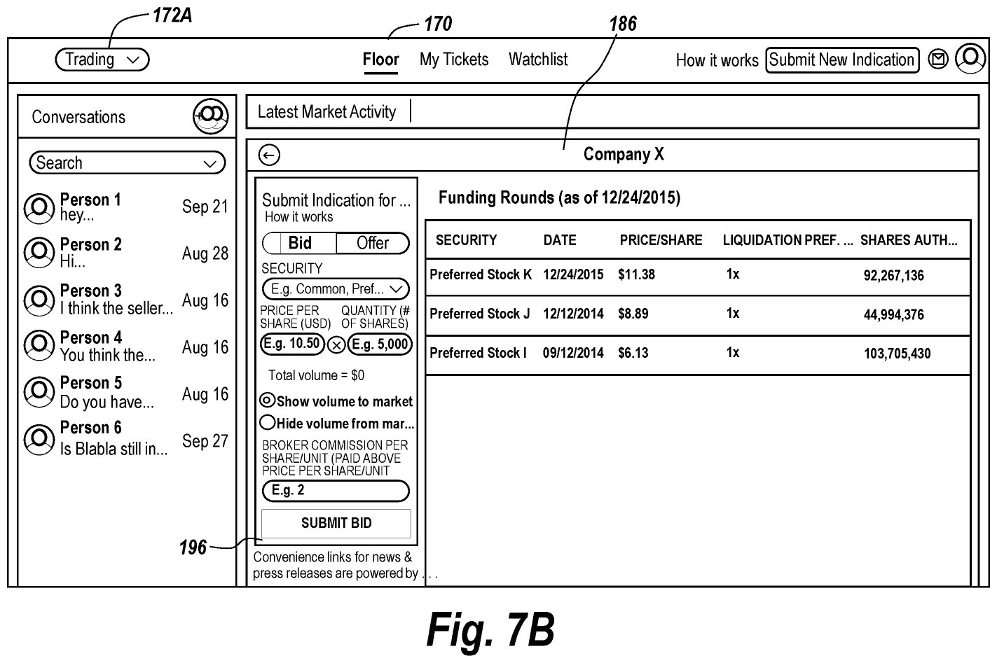

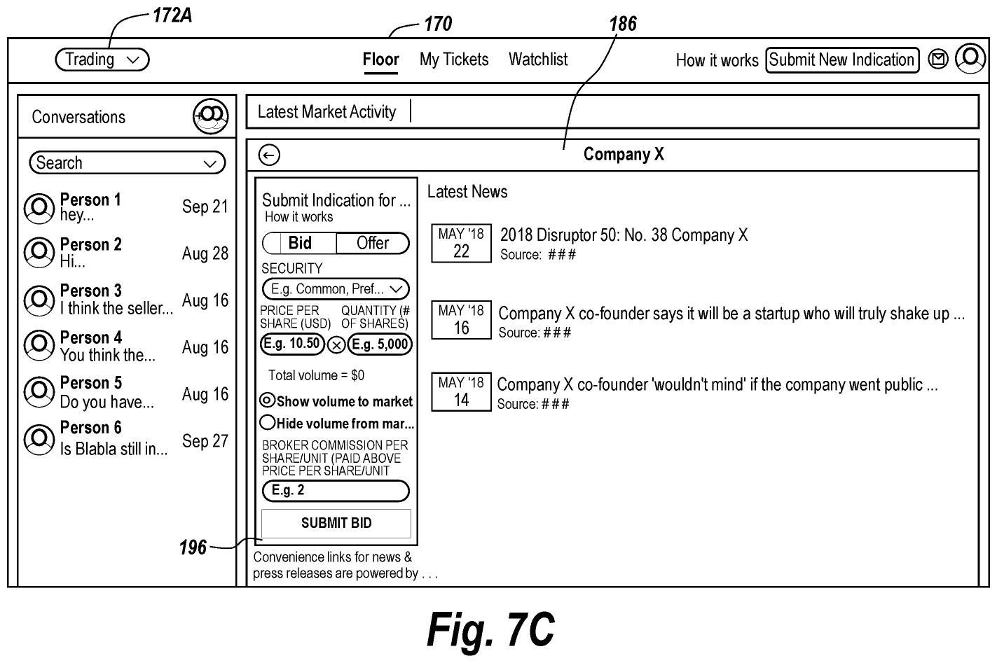

FIG. 7A shows the window 170 and the selected financial metrics associated with a specific company, for example, a selected company listed in FIG. 6. As shown in the current example, Company X was selected from FIG. 6 in the right pane element 186, and the right pane clement 186 of FIG. 7A now displays different information associated with Company X. The displayed information can include a company summary section 190 that includes highest bid and lowest offer data on an interest associated with the company, the number of live bids and offers on the interest, and the total bid offer volume and the total offer volume. The left pane element 186 also includes a Firm Orders section 192 that displays any firm bids or firm offers (e.g., firm orders) for an interest associated with Company X. As shown in the present example, a firm offer exists for a selected price per share and a firm bid exists for a selected price per share. The firm order enables one or more system users to place an offer or a bid on a selected interest of a company. In the current example, the system shows that a party, such as a subscriber or authorized user, has placed a firm offer to sell shares in Company X at a selected price (e.g., $7/share). If another subscriber or authorized user agrees to purchase the shares for the indicated price then the seller of the shares is obligated to sell the shares to the subscriber or authorized user purchasing the shares. If either party reneges or fails to conclude the sale of the shares, then an economic fee is assessed and paid by the breaching party to the other subscriber or authorized user. This economic fee is typically a broker fee of a predetermined amount. The broker fee is typically shared with the operator of the trading system 112. Prior to a subscriber or authorized user posting on the system a firm order, they initially submit an indication of interest for selling or buying shares in a selected company. If the subscriber or authorized user wishes to have the offer to sell or buy be binding, then the subscriber or authorized user can convert the indication of interest into a firm order by submitting to the trading system 112 selected authorization and/or verification information, in the form of documentation, indicating that the subscriber or authorized user has the authority to actually sell or buy the selected shares. This additional information enables the trading system 112 to convert the indication of interest (i.e., non-binding general interest) into a firm order (i.e., binding interest). The right pane element 186 also include a Tickets Submitted section 194 that lists the number and/or types of financial interests that a selected subscriber or authorized user has made in connection with a selected company, such as Company X.

The right pane element 186 also includes a user interface element 196. The user interface element 196 can include selected information that enables a subscriber or authorized user to submit a bid or offer in a selected interest of a company on the trading system 112 via a bid/offer user interface element portion 198 (i.e., an indication of interest). The information included in the user interface element 196 includes the ability to select whether the party is submitting a bid or an offer on a company, such as Company X. The user interface element 196 also includes a company user interface element portion 200 that allows the submitting party to select the specific company using a search or drop down menu box, as well as a share user interface element portion 202 that allows the submitting party to set forth the price per share and the number of shares. The user interface clement 196 also includes an economic fee user interface element portion 204 that allows the submitting party to set the economic fee (e.g., broker fee or commission) associated with the indication of interest or firm order. The economic fee can also function as the penalty fee in a firm order scenario when one or more of the parties to the proposed transaction fail to conclude the transaction. The user interface element 196 also includes a button 206 that allows the submitting party to submit a bid or offer

FIG. 7B illustrates the right pane element 186 of the window 170. The pane element can also be configured by the trading system 112 to display additional financial information about a selected company, such as Company X, including financial information associated with preferred stock transactions associated with the company. FIG. 7C shows that the right pane element 186 of the window 170 can also be configured to show other types of information associated with the company, including for example general news information about the company.

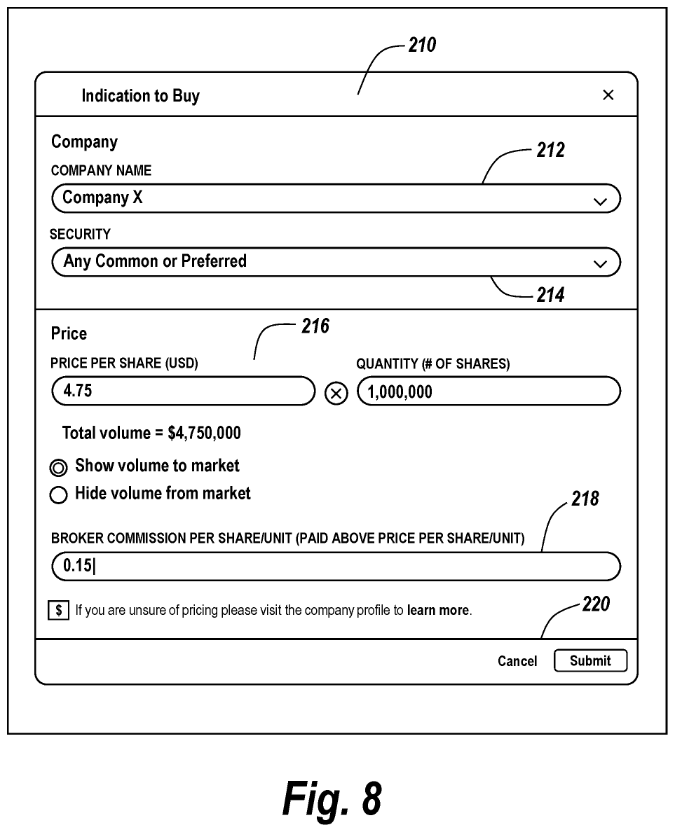

FIG. 8 illustrates the pop-up user interface element 210 that is displayed when the user or submitting party (e.g., the subscriber or authorized user) selects, activates or “clicks” on the submit bid button 206 shown in FIGS. 7A-7C. The pop up user interface element 210 allows the submitting party to verify the information provided in the original submission. The pop up user interface element 210 can include a company user interface element portion 212 that identifies and allows the user to select a specific company. As shown in the current example, Company X is selected by the submitting party. The stock user interface element portion 214 allows the submitting party to select the type or class of stock of the company being traded. The share user interface element portion 216 allows the submitting party to select the stock price per share and the number of shares that the submitting party is either offering to buy or sell. As shown, the present pop-up user interface element 210 is an indication to buy an interest. The economic fee user interface element portion 218 allows the submitting party to submit or set the economic fee associated with the proposed transaction. The soft buttons 220 allow the submitting party to formally submit the bid to buy the stock on the indicated financial terms or to cancel the proposed indication.

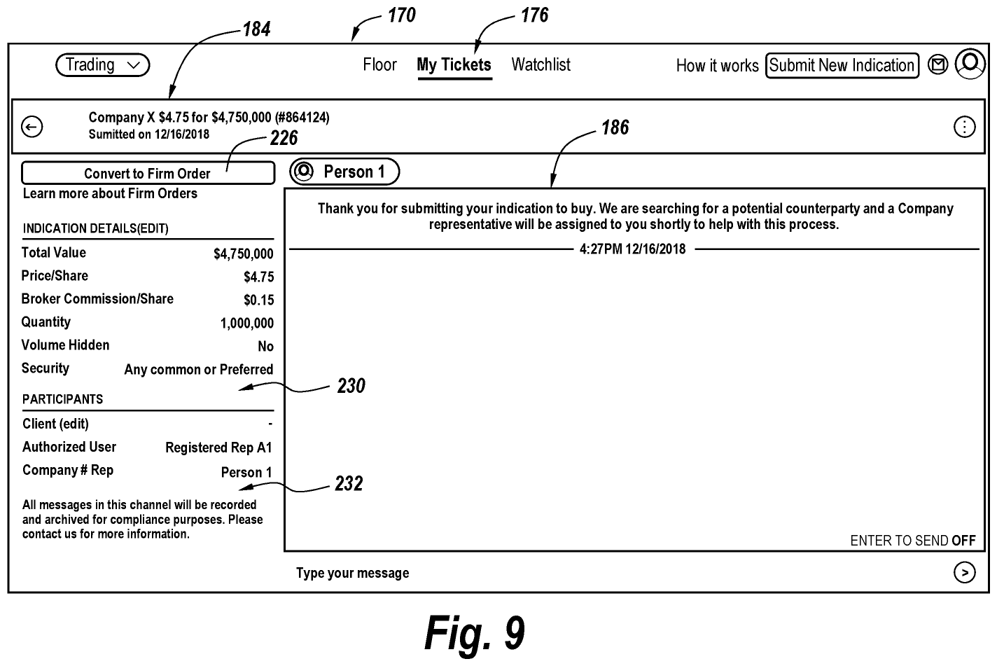

FIG. 9 illustrates the information capable of being displayed on the display elements of any suitable computing device 12, 16 when the My Ticket tab element 176 is selected by the subscriber or the authorized user. The illustrated left pane element 184 of the window 170 displays or sets forth the financial transaction information associated with the particular subscriber or authorized user as well as the particular company, such as Company X. As shown, the left pane element 184 includes a button 226 that allows the subscriber or authorized user to convert the indication of interest of the selected company into a firm order, which serves to bind together the parties to the execution of the trade of the selected interest. The left pane element 184 also includes an indication detail section 230 that sets forth selected financial information associated with the trade of the interest in, for example, Company X. In the illustrated example, the details of the interest include the total value of the shares, the price per share, the economic fee associated with the trade, and the number or quantity of shares. The left pane element 184 also includes a participants section 232 that lists identification information of the subscriber or authorized user associated with the proposed transaction. This information can include the client of the subscriber or authorized user, the identity of the authorized user and the representative associated with the trading system 112. The right pane element 186 sets forth if desired information regarding the status of the trade in the interest. In the illustrated example, the information is associated with a proposed purchase of the shares of Company X. If the proposed purchaser of the shares desires to convert the indication of interest in purchasing the shares into a firm order, that is, a binding order to purchase the shares, then the subscriber or authorized user clicks the soft button 226.

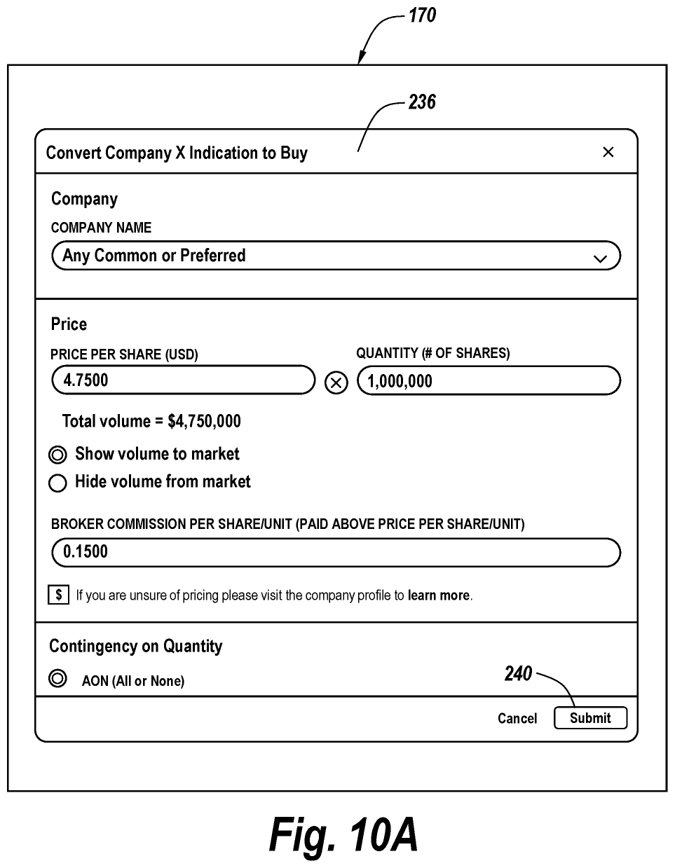

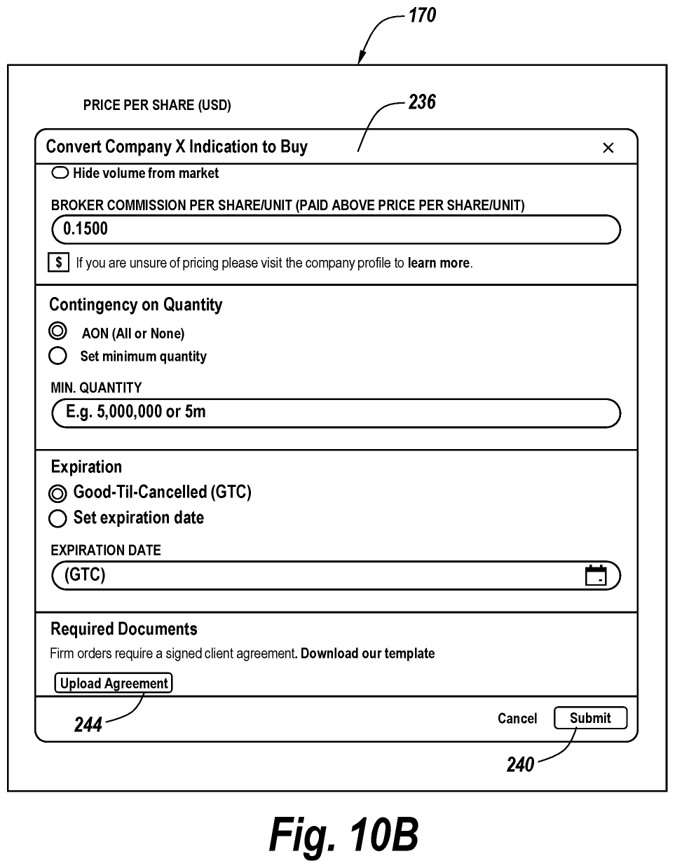

Once the button 226 is activated, then the window 170 shows the user interface element 236 that sets forth details of the firm order that the subscriber or authorized user is generating, as shown in FIGS. 10A and 10B. The user interface element 236 includes details including the company identification, the type of security, the number of shares, the price per share, and the economic fee. The user interface element 236 also includes additional information regarding the proposed purchase, including whether the subscriber or authorized user provides additional limitations on the transaction including contingencies on the shares and the expiration information on the proposed trade. The user interface element 236 also includes a section that indicates whether documents are required to be uploaded to the trading system 112. If the subscriber or authorized user wishes to convert an indication of interest into a firm order in the trading system 112, then the system requires that executed documents setting forth the authority of the subscriber or authorized user to submit such a trade request be uploaded to the system. This section includes an upload button 244 that allows the subscriber or authorized user to upload selected documents associated with the firm order into the storage element of the trading system 112. Further, the user interface element 236 includes one or more buttons for allowing the subscriber or authorized user to submit the trade request or cancel the trade request.

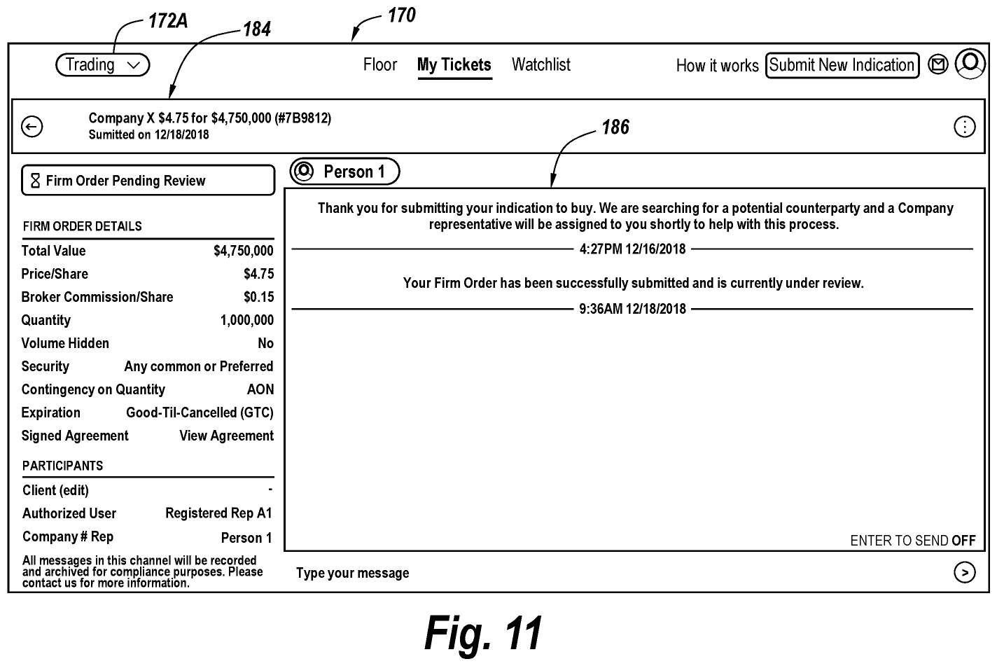

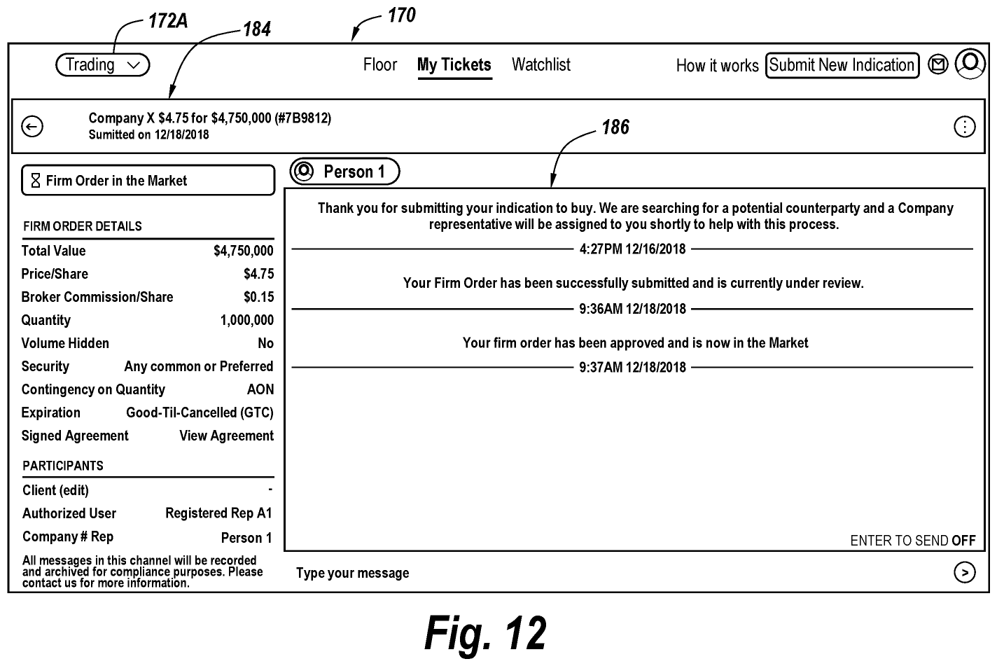

As shown in FIG. 11, once the executed documents are uploaded by the subscriber or authorized user into the trading system 112, then the left pane element 184 of the window indicates that the firm order submitted by the subscriber or authorized user is confirmed by the trading system pending further review by the trading system 112 for compliance with all necessary requirements. The left pane element 184 also sets forth details of the proposed trade, such as total value of the trade, price per share and the number of shares, contingency and expiration details associated with the trade, and participants associated with the trade. The signed agreement between the subscriber or authorized user and the customer represented thereby can be accessed from the storage element associated with the trading system 112. The right pane element 186 displays information regarding the status of the trade, including whether the indication of interest in the form of a request for a firm order has been accepted as well as whether a counterparty to the proposed trade has been found. Once the request for the firm order has been received, it is converted into a firm order once approved by the trading system 112. After approval, the left pane element 184 of the window 170 indicates that the firm order has been placed in the market on the trading system, FIG. 12. Once a counterparty to the transaction is identified, then the parties are bound to the transaction and the economic fee is due and binding upon the parties to the transaction.

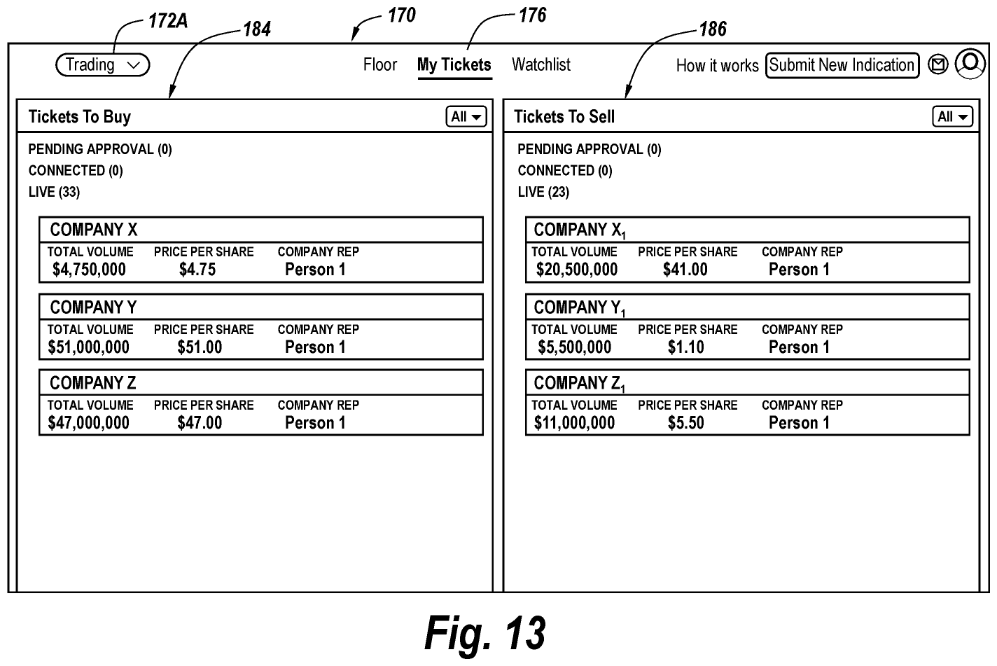

As shown in FIG. 13, the My Tickets tab 176 also presents information in the left and right pane elements 184, 186 of the window 170. The displayed information can include any information associated with the financial details of the trades associated with the particular subscriber or authorized user. For example, the left pane element 184 can include buy order information (e.g., tickets to buy) of various trades associated with the subscriber, and the right pane element 186 can include sell order information (e.g., tickets to sell) of various trades associated with the subscriber.

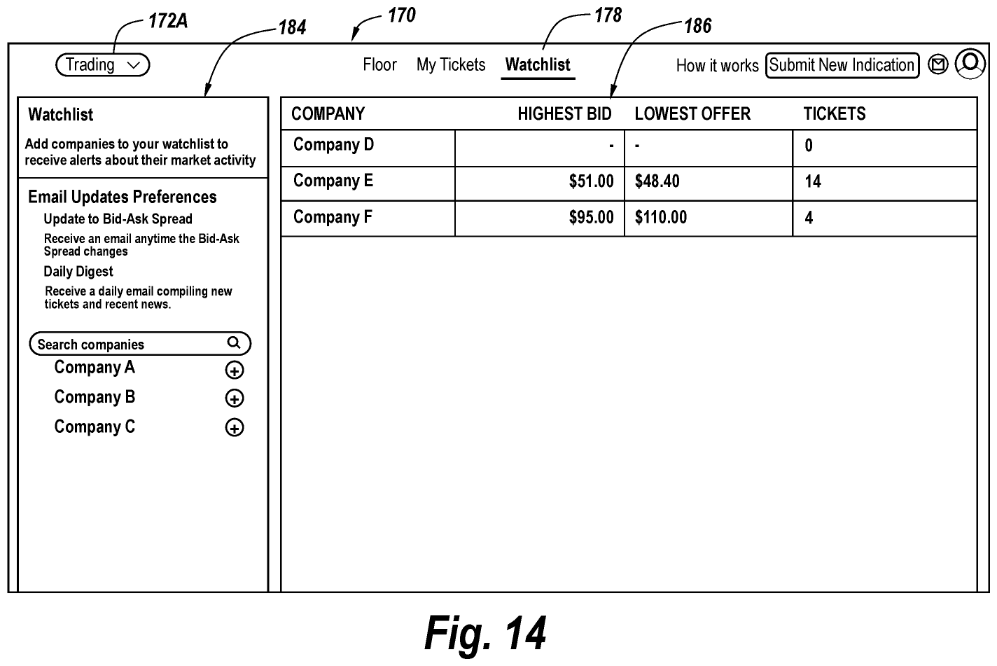

FIG. 14 illustrates the information displayed in the window 170 when the tab element 178 associated with the Watchlist is actuated by the subscriber or authorized user. The left pane element 184 displays information associated with various companies being traded on the trading system 112. The displayed information can include the company names which are searchable through associated search boxes. The subscriber or authorized user can also activate selected options in the pane element 184, including whether the user wishes to receive selected e-mail updates regarding news or financial information associated with selected companies. The financial information can include updates on bid-ask spreads and a daily digest (news and order/ticket information) on the selected company. The right pane element 186 can display companies selected by the subscriber or authorized user. The selected companies can be listed therein as well as other selected financial information, including information associated with the highest bid and lowest offer for assets (e.g., securities) in the companies, as well as the number of tickets (e.g., offers and bids) associated with each company.

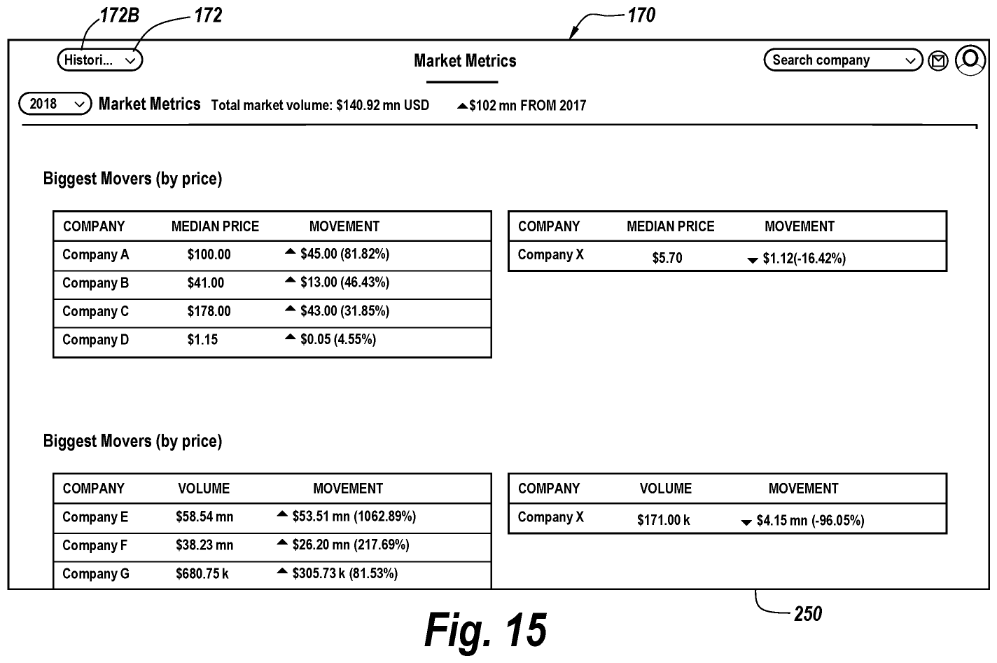

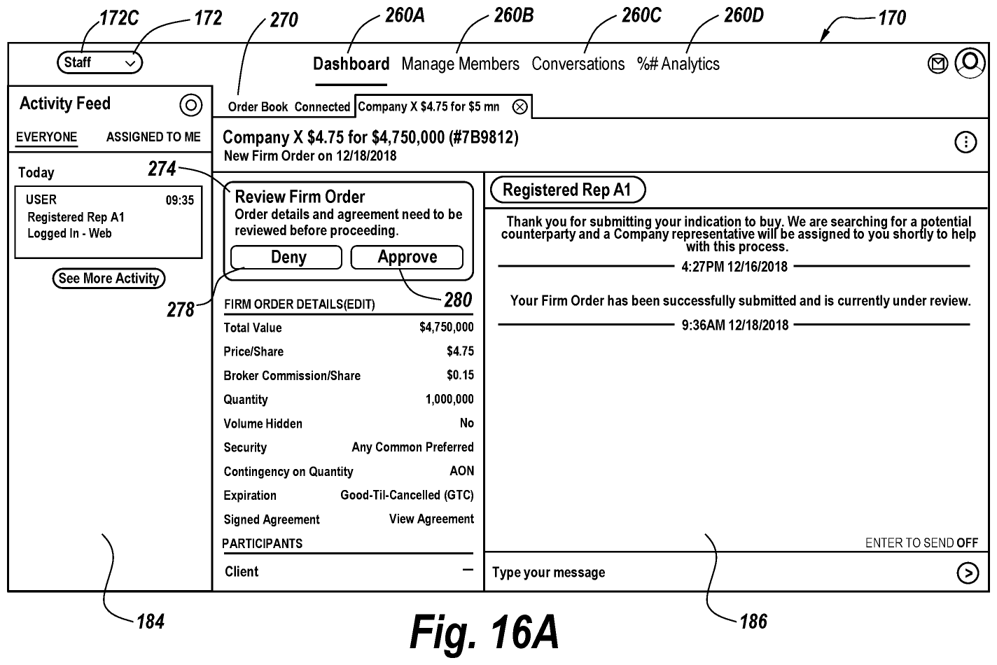

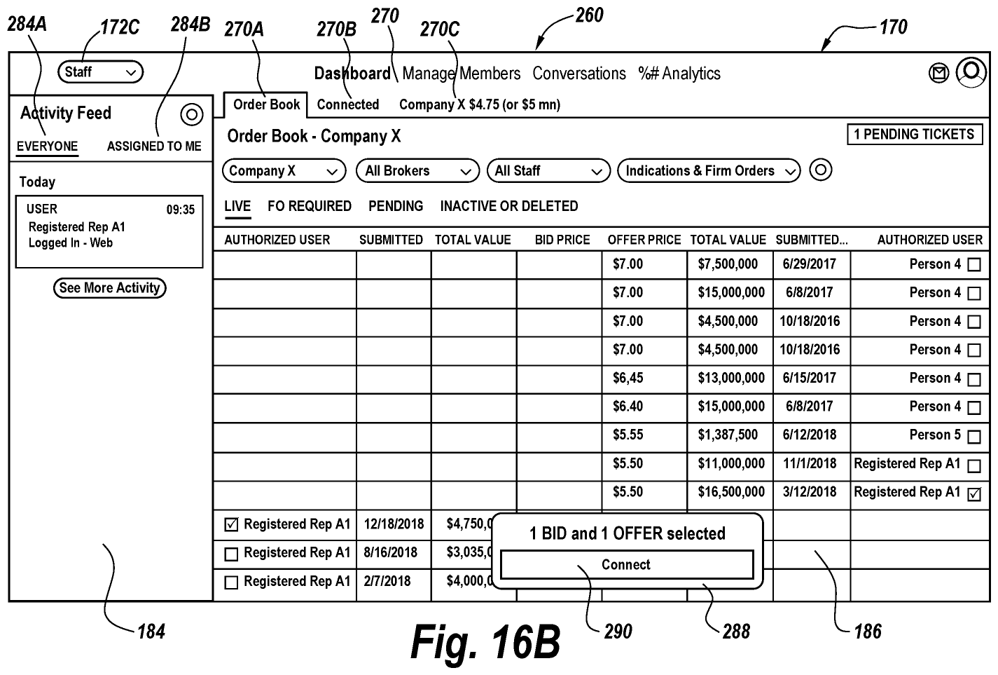

The drop down list element 172 can be switched by the user or by personnel associated with the trading system to access and display other types of information. For example, as shown in FIGS. 15, 16A and 16B, the drop down list element 172 can include in addition to the trading information item 172A associated with FIGS. 6-14, the drop down list can also include a historical information item 172B (FIG. 15) and a trading platform staff item 172C with associated information (FIGS. 16A, 16B). With reference to FIG. 15, the window 170 can include a user interface element 250 that displays selected financial information associated with companies selected by the subscriber or authorized user. According to the current example, the user interface element 250 displays the companies selected by the subscriber or authorized user, including selected types of financial data, such as the median price of the stock, stock price movement, as well as ranking the selected companies by stock price and stock price movement.

FIGS. 16A and 16B illustrate the various information displayed in the window 170 and the pane elements 184, 186 when the staff element 172C is selected from the drop down list 172. When the staff element 172C is selected, the window 170 includes one or more tab elements 260. Specifically, the window 170 includes a Dashboard tab element 260A, a Manage Members tab clement 260B, and a Conversations tab element 260C, and an Analytics tab element 260D. As shown, the information associated with the Dashboard tab element 260A is displayed. The right pane element 186 includes a sub-series of tab elements 270, including an Order Book tab element 270A, a Connected tab element 270B, and a selected Company tab element 270C. When the sub-series Company tab element 270C is selected, selected information associated with the company is displayed. As shown in the current example, selected financial information associated with Company X is displayed, including stock price, number of shares, total transaction value, broker fee, and contingency and expiration data. The pane element can also display information associated with the indication of interest firm order to inform the subscriber or authorized user of the status of the proposed trade or transaction. The trading system 112 reviews the displayed information when confirming a firm order. The pane element 186 also includes a user interface element 274 that prompts the trading system 112 to review the information associated with the pending firm order request. The trading system 112 allows a staff member to either approve or deny the firm order request by activating a Deny button 278 or an Approve button 280. The left pane element 184 displays an activity feed, and can include if desired one or more tab elements, including an Everyone tab element 284A and an Assigned to me tab element 284B. The Everyone tab element 284A enables the subscriber or authorized user to view the activity feeds of everyone active on the trading system 112, and the Assigned to me tab element 284B enables the subscriber or authorized user to view the activity feed of other subscribers or authorized users or of companies that have been selected.

FIG. 16B shows the information displayed in the right pane element 186 when the Order Book tab element 270A is selected. The pane element 186 can also display further tab elements for live, firm order required, pending and inactive order and indications of interest information. As shown in the current example, the trading system 112 can connect firm orders, as indicated by the user interface element 288. Once the trading system 112 determines that an offer and bid associated with a specific interest are aligned or match, then the system can connect the subscribers or authorized users on either side of the trade. In the current example, the trading system 112 connects the bid and offer (i.e., buy and sell) sides in a firm order context. The staff member can connect the bid and offer by actuating the connect button 290.

As noted above, the transactions desired to be offered by the subscriber or authorized user can be imported or submitted to the trading system 112. The documents necessary to complete the transaction can also be submitted to and handled by the trading system 112. Further, the transactions executed through the trading system 112 of the present invention may involve private securities and hence need not involve securities that are centrally cleared, but rather are cleared and settled by the parties to the transaction by means of suitable closing documents agreed to by the parties. The transactions posted on the trading system 112 can be executed and cleared by each of the subscribers representing the buyer and the seller executing a subscriber agreement, and the subscriber or authorized users in the case of a proprietary trade also execute the closing documents. The system can be configured so as not to receive or hold customer funds or securities. The clearance and settlement by subscribers are subject to the policies and approvals of such subscribers. The trading system 112 of the present invention thus enables a potential buyer and a potential seller that would like to move forward with a proposed transaction, have reached agreement on the price and payment particulars, and have been authorized by their sponsoring subscribers to use the trading system to electronically execute and upload documentation for listing an indication of interest that can be converted into a firm order, thus making the commitment firm and binding. Once the buyer and seller agree to execute the transaction, the terms of the trade are memorialized in the closing documentation and the parties are now obligated to complete the transaction.

Alternatively, the present invention also contemplates that the parties to the transaction may interact directly to review and execute the subscriber agreement, to negotiate directly to determine the terms and conditions of the transaction, as well as to determine the clearance and settlement particulars, via convenient and known communication tools and techniques. These interactions, in whole or in part, may occur off-line or outside of or independent of the trading system 112.

One or more of the above-described acts may be encoded as computer-executable instructions executable by processing logic, such as by the processor or CPU 30. The computer-executable instructions may be stored in any suitable non-transitory computer readable media. The computing device 100 may include one or more tangible non-transitory computer-readable storage media for storing one or more computer-executable instructions or software that may implement one or more embodiments of the invention. The non-transitory computer-readable storage media may be, for example, the memory or storage 24, 26, 32, 38 and 64, portable media or storage elements and other known storage types, examples of which include hard disks, compact discs, digital versatile discs, flash memory cards, a Programmable Read Only Memory (PROMs), Random Access Memory (RAM), Read Only Memory (ROM), Magnetoresistive Random Access Memory (MRAM), magnetic tapes, or other computer-readable media. One or more of the above described acts may be performed in a suitably-programmed electronic device, such as the computing device 100, which is suitable for processing, executing and implementing one or more of the acts disclosed herein. The computing or electronic device 100 is illustrative and may take other forms. For example, an alternative implementation of the electronic device 100 may have fewer components, more components, or components that are in a configuration that differs from the configuration shown in FIGS. 1A-1D. The features and components of the present invention described herein may be implemented using hardware based logic, software based logic and/or logic that is a combination of hardware and software based logic (e.g., hybrid logic). Therefore, the components illustrated in in the current Figures are not limited to a specific type of logic.

The processor 30 may include hardware based logic or a combination of hardware based logic and software to execute instructions on behalf of the computing device 100. The processor 30 may include logic that may interpret, execute, and/or otherwise process information contained in, for example, the memory 24, 26, 32, 38 and 64. The information may include computer-executable instructions and/or data that may implement one or more embodiments of the present invention. The processor 30 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores, and may include a system-on-chip (SoC) or system-in-package (SiP) configuration.

The foregoing description may provide illustration and description of various embodiments of the invention, but is not intended to be exhaustive or to limit the invention to the precise form disclosed. Modifications and variations of the trading system of the present invention may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware. Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

Further, the invention can be employed using any combination of features or elements as described above, and are not limited to the current recited steps or features.

It is intended that the invention not be limited to the particular embodiments disclosed above, but that the invention will include any and all particular embodiments and equivalents falling within the scope of the following appended claims.

We claim:

1. A method, implemented by a computing device, comprising
receiving an indication of an interest submitted by a first subscriber or authorized user for display on a user interface, wherein the indication of interest includes an interest in a private security,
receiving a request to convert the indication of interest into a firm order from the first subscriber or authorized user, the firm order having an economic fee associated therewith,
generating a request for authorization information from the first subscriber or authorized user indicating that the first subscriber or authorized user is authorized to convert the indication of interest into a firm order,
if the first subscriber or authorized user is authorized to submit the firm order, receiving authorization information from the first subscriber or authorized user, said authorization information being stored in the storage element,
converting the indication of interest into the firm order,
placing the firm order into a digital trading marketplace,
receiving a request from the second subscriber or authorized user to proceed with a transaction involving the firm order, and
matching the second subscriber or authorized user to the firm order submitted by the first subscriber or authorized user to form a trade, and once matched the economic fee is due and payable by one of the first subscriber or authorized user or the second subscriber or authorized user independent of completion of the trade.

2. The method of claim 1, further comprising receiving information associated with the indication of interest from the first subscriber or authorized user and stored in a storage element for review by a second subscriber or authorized user on the user interface.

3. The method of claim 1, wherein the receiving the indication of interest comprises receiving trade information including a company name, a number of shares to be traded, a price per share, a magnitude of the economic fee, and an indicator that the indication of interest is a bid or an offer.

4. The method of claim 3, further comprising receiving a request to submit the indication of interest with the trade information associated therewith.

5. The method of claim 4, further comprising generating information associated with the company for display on the user interface including a number of indications of interest associated with the company, a number of firm orders associated with the company, and bid offer information associated with the company.

6. The method of claim 4, wherein the bid and offer information comprises share price information offered on one or more shares of the company or share price information bid on one or more shares of the company.

7. A non-transitory storage medium storing instructions that cause a processor to:
receive an indication of an interest submitted by a first subscriber or authorized user for display on a user interface, wherein the indication of interest includes an interest in a private security,
receive a request to convert the indication of interest into a firm order from the first subscriber or authorized user, the firm order having an economic fee associated therewith,
generate a request for authorization information from the first subscriber or authorized user indicating that the first subscriber or authorized user is authorized to convert the indication of interest into a firm order,
if the first subscriber or authorized user is authorized to submit the firm order, receive authorization information from the first subscriber or authorized user, said authorization information being stored in the storage element,
convert the indication of interest into the firm order,
place the firm order into a digital trading marketplace,
receive a request from the second subscriber or authorized user to proceed with a transaction involving the firm order, and
match the second subscriber or authorized user to the firm order submitted by the first subscriber or authorized user to form a trade, and once matched the economic fee is due and payable by one of the first subscriber or authorized user or the second subscriber or authorized user independent of completion of the trade.

8. The non-transitory storage medium of claim 7, wherein the processor is further configured to receive information associated with the indication of interest from the first subscriber or authorized user and stored in a storage element for review by a second subscriber or authorized user on the user interface.

9. A computing device, comprising
a storage element,
a processor for executing instructions to:
receive an indication of an interest submitted by a first subscriber or authorized user for display on a user interface, wherein the indication of interest includes an interest in a private security,
receive a request to convert the indication of interest into a firm order from the first subscriber or authorized user, the firm order having an economic fee associated therewith,
generate a request for authorization information from the first subscriber or authorized user indicating that the first subscriber or authorized user is authorized to convert the indication of interest into a firm order,
if the first subscriber or authorized user is authorized to submit the firm order, receive authorization information from the first subscriber or authorized user, said authorization information being stored in the storage element,
convert the indication of interest into the firm order,
place the firm order into a digital trading marketplace,
receive a request from the second subscriber or authorized user to proceed with a transaction involving the firm order, and
match the second subscriber or authorized user to the firm order submitted by the first subscriber or authorized user to form a trade, and once matched the economic fee is due and payable by one of the first subscriber or authorized user or the second subscriber or authorized user independent of completion of the trade.

10. The system of claim 9, wherein the processor is further programmed to:
receive information associated with the indication of interest from the first subscriber or authorized user and stored in a storage element for review by a second subscriber or authorized user on the user interface.

11. A method, implemented by a computing device, comprising
transmitting a first user interface to obtain information from a first subscriber or authorized user for an indication of interest in a company, wherein the indication of interest includes an interest in a private security,
receiving from the first subscriber or authorized user the information about the indication of interest in the company, the information about the indication of interest in the company being stored in a storage element,
receiving information associated with the indication of interest from the first subscriber or authorized user and stored in a storage element for review by a second subscriber or authorized user on the user interface,
transmitting to the first subscriber or authorized user a second user interface to obtain instructions to convert the indication of interest into a firm order, the firm order having an economic fee associated therewith,
receiving from the first subscriber or authorized user a request to convert the indication of interest into a firm order,
transmitting a third user interface to obtain authorization information authorizing the first subscriber or authorized user to convert the indication of interest into the firm order,
if the first subscriber or authorized user is authorized to submit the firm order, receiving the authorization information from the first subscriber or authorized user, the authorization agreement being stored in the storage element,
converting the indication of interest into the firm order,
placing the firm order into an on-line trading marketplace,
receiving a request from a second subscriber or authorized user to proceed with a transaction involving the firm order, and
matching the second subscriber or authorized user to the firm order submitted by the first subscriber or authorized user to form a trade, and once matched the economic fee is due and payable by one of the first subscriber or authorized user or the second subscriber or authorized user independent of completion of the trade.

12. In a digital trading marketplace for trading interests in a company, a computer-implemented method of trading the interests, the method comprising
generating a window element having along one side a drop down menu list element having a plurality of menu items associated therewith,
a plurality of window tab elements disposed in a row along a top portion of the window element,
a button element disposed along the top portion of the window, the button element allowing a user to input an indication of interest in a selected company, and
a left pane element and right pane element, wherein the right and left pane elements form part of the window, the left pane element displaying on a display element messages associated with selected users of the trading marketplace, and the left pane element displaying on a display information associated with each of the plurality of window tab elements.

13. The method of claim 12, wherein the plurality of menu items of the drop down menu list element comprises a first menu item element for displaying on a display when selected interests in companies to be traded in the digital trading marketplace, a second menu item element for displaying on the display information associated with a plurality of companies, and a third menu item element for displaying on the display information firm order information for use by personnel of the trading marketplace.

14. The method of claim 13, wherein the first menu list element includes a trading menu item element, the second meu item element includes a historical menu item element, and a third menu item element includes a staff menu item element.

15. The method of claim 12, wherein the plurality of window tab elements comprise a first tab element for displaying trading activity associated with the trading marketplace

16. The method of claim 12, further comprising, when the button element is selected, generating a user interface element for display in the window to allow a subscriber or authorized user to submit trading information associated with the selected company.

17. The method of claim 16, further comprising selecting one of the plurality of menu items of the drop down menu list element, and when selected, generating in the right pane element a plurality of second tab elements disposed in a row.

18. A method, comprising
receiving an indication of an interest submitted by a first subscriber or authorized user for display on a user interface, wherein the indication of interest includes an interest in a private security,
receiving a request to convert the indication of interest into a firm order from the first subscriber or authorized user, the firm order having an economic fee associated therewith,
requesting authorization information from the first subscriber or authorized user indicating that the first subscriber or authorized user is authorized to convert the indication of interest into a firm order,
if the first subscriber or authorized user is authorized to submit the firm order, receiving authorization information from the first subscriber or authorized user, said authorization information being stored in the storage element,
converting the indication of interest into the firm order,
receiving a request from the second subscriber or authorized user to proceed with a transaction involving the firm order, and
matching the second subscriber or authorized user to the firm order submitted by the first subscriber or authorized user to form a trade, and once matched the economic fee is due and payable by one of the first subscriber or authorized user or the second subscriber or authorized user independent of completion of the trade.
